(19) United States
(12) Patent Application Publication
(10) Pub. No.: US 2026/0361574 A1
(43) Pub. Date: Nov. 12, 2026

(54) OPTIMIZATION OF CHANNEL INFORMATION SIGNALING IN FRONTHAUL INTERFACE

(71) Applicant: QUALCOMM Incorporated, San Diego, CA (US)

(72) Inventors: Akashnil ROY, Kolkata (IN); Aman Kumar SINGH, Hyderabad (IN)

(21) Appl. No.: 19/203,870

(22) Filed: May 9, 2025

(51) Int. Cl. H04L 25/02; H04L 5/00

(52) U.S. Cl. CPC H04L 25/0228; H04L 5/0051

(57) ABSTRACT

Aspects relate to a wireless communication system for wireless communication. The wireless communication system may include a network node that receives an antenna configuration message associated with a plurality of antennas. The antenna configuration message indicates a set of active antennas of the plurality of antennas and a set of inactive antennas of the plurality of antennas. The network node receives a sounding reference signal (SRS) associated with a user equipment. The network node generates, based on the antenna configuration message and the SRS, a control plane (C-plane) message. The C-plane message indicates a first set of channel estimates for the set of active antennas. In the C-plane message, a second set of channel estimates for the set of inactive antennas is absent. The network node transmits the C-plane message.

### BACKGROUND

### Field of the Disclosure

The present disclosure relates generally to wireless communication systems, and, more particularly, to channel information signaling in fronthaul interface.

### Description of Related Art

Wireless communication systems are widely deployed to provide a range of communication services such as telephony, data transmission, messaging, multimedia streaming, broadcasting, or the like. The wireless communication systems may enable communication between multiple users by employing various multiple-access technologies, for example, Code Division Multiple Access (CDMA), Time Division Multiple Access (TDMA), Frequency Division Multiple Access (FDMA), Orthogonal Frequency Division Multiple Access (OFDMA), or the like. Examples of wireless multiple-access communication systems may include fourth-generation (4G) systems such as Long-Term Evolution (LTE) systems, LTE-Advanced (LTE-A) systems, or LTE-A Pro systems, and fifth-generation (5G) systems which may be referred to as New Radio (NR) systems. A wireless multiple-access communication system may include one or more base stations that enable wireless communication for communication devices such as User Equipment (UE).

In the context of an Open Radio Access Network (O-RAN) architecture, functions of a base station or a network node may be divided across multiple devices or components. For example, an O-RAN network node may include a Radio Unit (RU) and a Distributed Unit (DU). The RU may handle wireless communications with devices, such as UEs, whereas the DU may support the wireless communications performed by the RU. The division of O-RAN network nodes may enable flexibility and scalability but may also involve an exchange of information between the DU and RU to ensure seamless operation. One such interaction may involve the RU transmitting configuration details to the DU to enable various operations such as resource allocation, time and frequency domain scheduling, Multiple Input Multiple Output (MIMO) user scheduling, or the like. As communication demands increase, there are opportunities to optimize communication interactions between the RU and the DU.

### SUMMARY

Aspects of the disclosure provide a first network node for wireless communication. The first network node includes one or more memories and one or more processors coupled to the one or more memories. The one or more processors are individually or collectively configured to cause the first network node to receive, from a second network node, an antenna configuration message associated with a plurality of antennas. The antenna configuration message indicates a set of active antennas of the plurality of antennas and a set of inactive antennas of the plurality of antennas. Further, the one or more processors are individually or collectively configured to cause the first network node to receive a first sounding reference signal (SRS) associated with a user equipment (UE). Further, the one or more processors are individually or collectively configured to cause the first network node to generate based on the antenna configuration message and the first SRS, a first control plane (C-plane) message that indicates a first set of channel estimates for the set of active antennas. In the first C-plane message, a second set of channel estimates for the set of inactive antennas is absent. Furthermore, the one or more processors are individually or collectively configured to cause the first network node to transmit the first C-plane message to the second network node.

In some aspects of the disclosure, a first network node for wireless communication is provided. The first network node has one or more memories and one or more processors coupled to the one or more memories. The one or more processors are individually or collectively configured to cause the first network node to transmit, to a second network node, an antenna configuration message associated with a plurality of antennas. The antenna configuration message indicates a set of active antennas of the plurality of antennas and a set of inactive antennas of the plurality of antennas. Further, the one or more processors are individually or collectively configured to cause the first network node to receive, from the second network node, a first control plane (C-plane) message based on the transmission of the antenna configuration message. The first C-plane message indicates a first set of channel estimates for the set of active antennas. In the first C-plane message, a second set of channel estimates for the set of inactive antennas is absent.

In some more aspects of the disclosure, a wireless communication method in a first network node is provided. The wireless communication method includes receiving, from a second network node, an antenna configuration message associated with a plurality of antennas. The antenna configuration message indicates a set of active antennas of the plurality of antennas and a set of inactive antennas of the plurality of antennas Further, the wireless communication method includes receiving a first sounding reference signal (SRS) associated with a user equipment (UE). Furthermore, the wireless communication method includes generating, based on the antenna configuration message and the first SRS, a first control plane (C-plane message) that indicates a first set of channel estimates for the set of active antennas. In the first C-plane message, a second set of channel estimates for the set of inactive antennas is absent. The wireless communication method further includes transmitting the first C-plane message to the second network node.

### BRIEF DESCRIPTION OF THE DRAWINGS

Various aspects of the present disclosure are illustrated by way of example, and not limited by the appended figures, in which like references indicate similar elements:

FIG. 1 is a diagram that illustrates an example of an Open Radio Access Network (O-RAN) architecture, in accordance with certain aspects of the present disclosure;

FIG. 2 is a diagram that illustrates an example of a message flow between a Distributed Unit (DU) and a Radio Unit (RU), in accordance with certain aspects of the present disclosure;

FIG. 3 is a diagram that illustrates an example of a message flow between a Distributed Unit (DU) and a Radio Unit (RU), in accordance with certain aspects of the present disclosure;

FIG. 4 is a diagram that illustrates an example of a first control plane (C-plane) message, in accordance with certain aspects of the present disclosure;

FIG. 5 is a diagram that illustrates an example of a first C-plane message, in accordance with certain aspects of the present disclosure;

FIG. 6 is a diagram that illustrates a high-level flowchart of a process (e.g., a method) for wireless communication, in accordance with certain aspects of the present disclosure;

FIG. 7 is a diagram that illustrates a flowchart of a process (e.g., a method) for wireless communication, in accordance with certain aspects of the present disclosure;

FIG. 8 is a diagram that illustrates a flowchart of a process (e.g., a method) for wireless communication, in accordance with certain aspects of the present disclosure;

FIG. 9 is a diagram that illustrates a flowchart of a process (e.g., a method) for wireless communication, in accordance with certain aspects of the present disclosure;

FIG. 10 is a diagram that illustrates an example of a DU, in accordance with certain aspects of the present disclosure; and

FIG. 11 is a diagram that illustrates an example of an RU, in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the disclosure will now be presented with reference to an apparatus and method. Such apparatus and method will be described in the following detailed description and illustrated in the accompanying drawings by various blocks, modules, components, circuits, steps, processes, or the like (collectively referred to as “elements”).

Accordingly, in one or more aspects, the functions described by elements of the disclosure may be implemented in hardware, software, or any combination thereof depending upon the particular application and design constraints imposed on the overall apparatus. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

At least one of a host processor, a processing core, an input/output controller, or any portion of any of such components, or any combination of such components may be implemented as a “processing system” that may include one or more processors. Examples of processors include microprocessors, microcontrollers, graphics processing units, central processing units, application processors, digital signal processors, reduced instruction set computing processors, systems on a chip, baseband processors, field programmable gate arrays, programmable logic devices, state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

An Open Radio Access Network (O-RAN) architecture may enable the functions of a base station to be distributed across multiple devices or components. For example, a network node within the O-RAN architecture may correspond to a Radio Unit (RU) and/or a Distributed Unit (DU). The RU may handle wireless communications with communication devices, such as User Equipment (UE), while the DU may support the wireless communications performed by the RU. While the division of base station functionalities allows for flexibility and scalability, the division of base station functionalities may include an exchange of information between the RU and the DU.

One such interaction between the RU and DU may involve the RU transmitting a control plane (C-plane) message to the DU to enable the DU to perform various functions such as resource allocation, time and frequency domain scheduling, Multiple Input Multiple Output (MIMO) user scheduling, or the like. For example, the RU may communicate configuration details (e.g., channel estimates) for channels between antennas associated with the RU and a user equipment (UE) to enable resource allocation for the UE.

In many scenarios, the RU transmits the channel estimates without accounting for the operational status of the antennas. For example, the channel estimates are transmitted indiscriminately for all antennas, regardless of whether the antennas are enabled or disabled. Accordingly, redundant information related to disabled antennas is transmitted over a fronthaul interface between the RU and DU. The transmission of redundant information consumes additional bandwidth and increases communication overhead in the fronthaul interface. Further, the transmission of redundant information may increase processing requirements on both the RU and DU, which in turn can lead to higher latency, reduced resource availability, and impact overall network performance.

Certain aspects disclosed herein provide systems and methods for optimization of channel information signaling in fronthaul interface. In an example, the RU may receive an antenna configuration message associated with a plurality of antennas from the DU. The antenna configuration message may indicate a set of active antennas of the plurality of antennas and a set of inactive antennas of the plurality of antennas. The RU may further receive a sounding reference signal (SRS) associated with a UE. Further, the RU may generate, a first control plane (C-plane) message based on the antenna configuration message and the first SRS. The first C-plane message may indicate a first set of channel estimates for the set of active antennas. Additionally, in the first C-plane message, a second set of channel estimates for the set of inactive antennas is absent. In an example, an active antenna of the set of active antennas may correspond to (or include) a first antenna of the plurality of antennas that is to be activated (or that shall remain active, turned ON). Further, an inactive antenna of the set of inactive antennas may correspond to a second antenna of the plurality of antennas that is to be deactivated (or that shall remain inactive, turned OFF). The second antenna may be different from the first antenna within the plurality of antennas. The RU may further transmit the first C-plane message to the DU. Since the second set of channel estimates is absent in the first C-plane message, the second set of channel estimates may not be relayed to the DU via the fronthaul interface. Thus, the overhead in the fronthaul interface may be reduced, which in turn may enable to improve network performance, such as network latency, network bandwidth, or the like.

In some aspects, each channel estimate of the first set of channel estimates is associated with an antenna identifier of a corresponding active antenna of the set of active antennas, in the first C-plane message. After the transmission of the first C-plane message, the RU may further receive a second SRS associated with the UE. Further, the RU may determine a third set of channel estimates for the set of active antennas based on the second SRS. Additionally, the RU may generate a second C-plane message that indicates one or more channel estimates of the determined third set of channel estimates. The one or more channel estimates of the determined third set of channel estimates indicated in the second C-plane message deviate from corresponding one or more channel estimates of the first set of channel estimates. In other words, the one or more channel estimates of the determined third set of channel estimates indicated in the second C-plane message are different from the corresponding one or more channel estimates of the first set of channel estimates. Further, in the second C-plane message, one or more channel estimates of the third set of channel estimates that are identical to corresponding one or more channel estimates of the first set of channel estimates, are absent. The RU may further transmit the second C-plane message to the DU. Since the one or more channel estimates of the third set of channel estimates that are identical to the corresponding one or more channel estimates of the first set of channel estimates are absent in the second C-plane message, the one or more channel estimates may not be communicated to the DU via the fronthaul interface. Thus, the overhead in the fronthaul interface may be further reduced during the transmission of the second C-plane message from the RU to the DU.

In further aspects, the antenna configuration message may include a bitmap having a plurality of bits, where each bit of the plurality of bits is mapped to a corresponding antenna of the plurality of antennas. Additionally, each bit of the plurality of bits has one of a first value indicating that the corresponding antenna is active, or a second value indicating that the corresponding antenna is inactive. In the first C-plane message, the first set of channel estimates for the set of active antennas is indicated in a same sequence in which the set of active antennas is indicated in the bitmap of the third C-plane message. Since the first set of channel estimates in the first C-plane message is indicated in the same sequence in which the set of active antennas are indicated in the third C-plane message, the DU may be enabled to not perform additional processes, such as performing a mapping between the first set of channel estimates and the set of active antennas, determining which channel estimate among the first set of channel estimates corresponds to an antenna of the plurality of antennas, or the like. Accordingly, the demand for the computation resources of the DU may be reduced.

The terms “Radio Unit” (RU) and “Distribution Unit” (DU) are used herein for illustrative and descriptive purposes to reference functional components within a wireless communication network. These terms are not intended to limit the scope of the disclosure to any specific terminology or technology. It will be apparent to a person skilled in the art that as technology evolves, these network nodes may be referred to by different names or have different functional groupings. Therefore, the terms RU and DU may encompass equivalent structures, devices, or functional units regardless of the terminology used in future technologies or implementations.

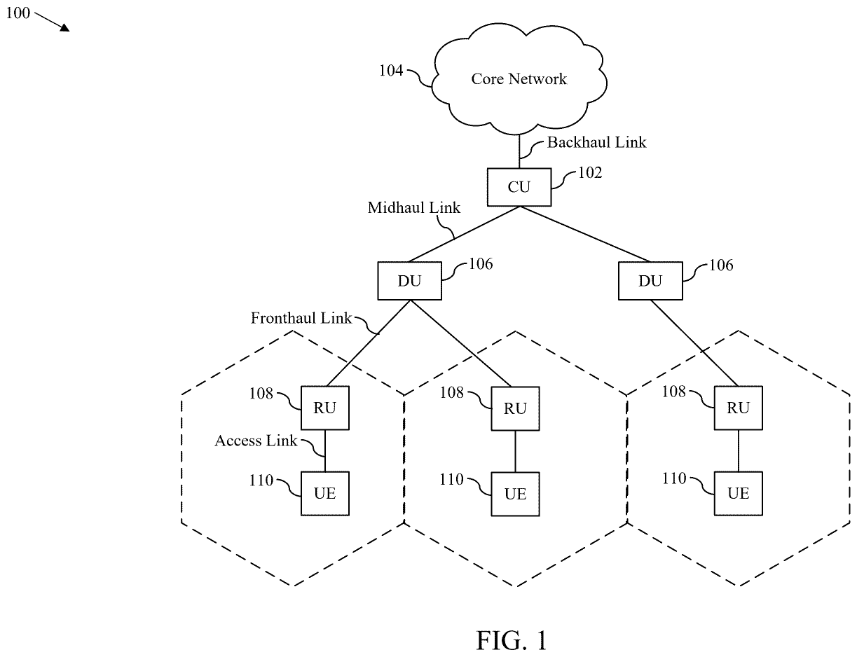

FIG. 1 is a diagram that illustrates an example of an Open Radio Access Network (O-RAN) architecture 100, in accordance with certain aspects of the present disclosure. In various aspects, the O-RAN architecture 100 may be implemented by one or more network nodes of a wireless communication system. In an example, the wireless communication system may include a fourth-generation (4G) system, a fifth-generation (5G) system, future generations, or the like. For example, a network node of the network nodes may include a New Radio (NR) base station, a Long-Term Evolution (LTE) base station, a Node B, an Evolved Node B (eNB), a Next Generation Node B (gNB), a Radio Access Network (RAN) node, an access point, a transmission-reception point (TRP), a mobile entity of a wireless communication network, or the like.

As shown in FIG. 1, the O-RAN architecture 100 may include a Central Unit (CU) 102 that is communicatively coupled to a core network 104 via a backhaul link. In an example, the CU 102 may be implemented within the network node of the one or more network nodes. Further, the O-RAN architecture 100 may include one or more Distributed Units (DUs) 106 and one or more Radio Units (RUs) 108. The DUs 106 may be communicatively coupled to the CU 102 via a respective midhaul link. Further, the DUs 106 may be communicatively coupled to at least one corresponding RU of the RUs 108 via at least one respective fronthaul link. The DUs 106 may be co-located with the CU 102, or alternatively, may be distributed across one or more different network nodes of the network nodes. Each of the RUs 108 may be co-located with a corresponding DU of the DUs 106, or alternatively, may be distributed across a different network node of the network nodes. Further, the RUs 108 may be communicatively coupled to at least one corresponding User Equipment (UE) 110 via a respective radio frequency (RF) access link. Examples of the UE 110 may include a cellular phone, a personal digital assistant (PDA) device, a wireless modem, a wireless communication device, a handheld device, a laptop computer, a wireless local loop (WLL) station, a tablet, a camera, a gaming device, a wearable device, or the like.

In various aspects, the CU 102 may host one or more higher-layer control functions for network control and/or signaling. In an example, the higher-layer control functions may include Radio Resource Control (RRC) functions, Packet Data Convergence Protocol (PDCP) functions, Service Data Adaptation Protocol (SDAP) functions, or the like. Each higher-layer control function of the higher-layer control functions may be implemented with an interface that is configured to communicate signals with remaining higher-layer control functions hosted by the CU 102. Further, the CU 102 may be configured to handle a user plane functionality (for example, a Central Unit-User Plane (CU-UP) functionality), a control plane functionality (for example, a Central Unit-Control Plane (CU-CP) functionality), or a combination thereof. In some aspects, the CU 102 may be logically split into one or more CU-UP units and one or more CU-CP units to handle the user plane functionality and the control plane functionality, respectively. In some more aspects, the CU 102 may be implemented to communicate with the DUs 106 for the network control and/or signaling.

Each of the DUs 106 may correspond to a logical unit that includes one or more base station functions to control the operation of the corresponding RU of the RUs 108. In further aspects, each of the DUs 106 may host one or more of a Radio Link Control (RLC) layer, a Medium Access Control (MAC) layer, and one or more high-physical (high-PHY) layers depending, at least in part, on a functional split, such as a functional split defined by the 3rd Generation Partnership Project (3GPP). Further, each layer hosted by a DU 106 of the DUs 106 may be implemented with an interface that is configured to communicate signals with remaining layers hosted by the DU 106, or with the higher-layer control functions hosted by the CU 102. In some implementations, the DUs 106 may host the high-PHY layers for forward error correction (FEC) encoding and decoding, scrambling, or modulation and demodulation, for example.

In some aspects, the DU 106 may be configured to transmit an antenna configuration message associated with a plurality of antennas to the RU 108. The antenna configuration message may indicate a set of active antennas of the plurality of antennas and a set of inactive antennas of the plurality of antennas. The DU 106 may be configured to receive a control plane (C-plane) message based on the transmission of the antenna configuration message. The C-plane message may indicate a first set of channel estimates for the set of active antennas. Additionally, in the C-plane message, a second set of channel estimates for the set of inactive antennas may be absent. A channel estimate for an antenna may refer to a representation of a current state of a communication channel between the corresponding antenna and the UE 110. In an example, the channel estimate may be represented in a form of an amplitude and a phase of a signal that is received or transmitted through the channel for the corresponding antenna. Since the second set of channel estimates for the set of inactive antennas is absent in the C-plane message, a size of the C-plane message may be reduced in comparison to a C-plane message that includes the first set of channel estimates for the set of active antennas and the second set of channel estimates the set of inactive antennas. The C-plane message may be received via the respective fronthaul link. As the C-plane message does not include the second set of channel estimates for the set of inactive antennas, overhead in the fronthaul link is reduced.

Each of the RUs 108 may implement one or more lower-layer functionalities depending, at least in part, on the functional split defined by the 3GPP. The lower-layer functionalities may correspond to one or more low-physical (low-PHY) layer functions supported by a low-PHY layer or one or more RF processing functions. For example, the lower-layer functionalities may include performing a Fast Fourier Transform (FFT), performing an inverse Fast Fourier Transform (iFFT), digital beamforming, or Physical Random-Access Channel (PRACH) extraction and filtering. In some aspects, each RU of the RUs 108 may be controlled by the corresponding DU of the DUs 106 to handle over-the-air (OTA) communication with the UE 110. In some implementations, to handle the OTA communication, the DUs 106 may control one or more real-time, near real-time, or non-real-time aspects of control plane (C-plane) communication (and/or user plane “U-plane” communication) with the RUs 108.

In some aspects, the RU 108 may be configured to receive the antenna configuration message from the DU 106. The antenna configuration message may indicate the set of active antennas of the plurality of antennas and the set of inactive antennas of the plurality of antennas. The RU 108 may be configured to receive a sounding reference signal (SRS) associated with the UE 110. An SRS may indicate characteristics of a communication channel between a UE (for example, the UE 110) and a base station (for example, the DU 106, the RU 108, or a combination of the DU 106 and the RU 108). The characteristics of a communication channel may include path loss, delay spread, Doppler shift, signal-to-noise ratio, interference levels, multipath fading, angle of arrival, angle of departure, channel reciprocity, transmission power requirements, or the like. In various aspects, the RU 108 may receive the SRS from the UE 110.

The RU 108 may be configured to generate the first C-plane message based on the antenna configuration message and the SRS. The first C-plane message may indicate the first set of channel estimates for the set of active antennas. Additionally, in the first C-plane message, the second set of channel estimates for the set of inactive antennas is absent. The RU 108 may be configured to transmit the first C-plane message to the DU 106. Since the second set of channel estimates for the set of inactive antennas is absent in the C-plane message, a size of the C-plane message may be reduced in comparison to a C-plane message that includes the first set of channel estimates for the set of active antennas and the second set of channel estimates the set of inactive antennas.

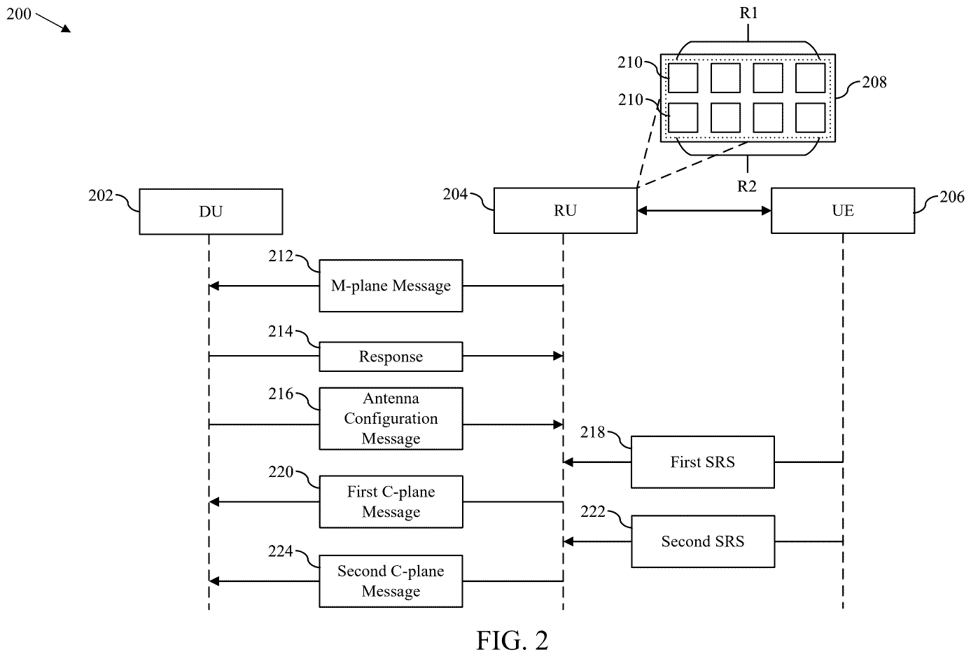

The RU 108 may transmit the C-plane message to the DU 106. The C-plane message may be transmitted via the respective fronthaul link. As the C-plane message does not include the second set of channel estimates for the set of inactive antennas, overhead in the fronthaul link is reduced. In an example, the transmission of the C-plane message to the DU 106 may be referred to as channel information signaling in fronthaul interface. The channel information signaling in the fronthaul interface is further explained in detail in conjunction with FIGS. 2-11.

FIG. 2 is a diagram that illustrates an example of a message flow 200 between a DU 202, an RU 204, and a UE 206, in accordance with certain aspects of the present disclosure. The DU 202 may be structurally and functionally similar to the DU 106. Further, the RU 204 may be structurally and functionally similar to the RU 108. Additionally, the UE 206 may be structurally and functionally similar to the UE 110. In various examples, the DU 202 and the RU 204 may be a part of the O-RAN architecture 100.

The DU 202 may be communicatively coupled to the RU 204 via a fronthaul interface (for example, the fronthaul link). As shown in FIG. 2, the RU 204 may be communicatively coupled to the UE 206. Additionally, the RU 204 may be communicatively coupled to at least one antenna array 208. The antenna array 208 may include a plurality of antennas 210. Each antenna of the plurality of antennas 210 may be configured to transmit (and/or receive) at least one wireless signal. Examples of the plurality of antennas 210 may include patch antennas, dipole antennas, or the like, which may be arranged in a linear pattern, a two-dimensional pattern, or a different pattern. In a non-limiting example shown in FIG. 2, the plurality of antennas 210 may include eight antennas, with four antennas being arranged in each of a first row R1 and a second row R2 of the antenna array 208. That is to say, the plurality of antennas 210 may include first through eighth antennas with the first through fourth antennas being arranged in the first row R1 and the fifth through eighth antennas being arranged in the second row R2. The antenna array 208 may be integrated within a network node that hosts the RU 204, or alternatively, may be located outside the network node that hosts the RU 204.

In some aspects, the RU 204 may utilize the plurality of antennas 210 to perform wireless communication with the UE 206. In an example, the wireless communication may be performed by forming one or more beams using the plurality of antennas 210. In some examples, the beamforming may involve generating a beam by phase-shifting wireless signals associated with different antennas of the plurality of antennas 210. The generated beam may carry data, such as physical information or reference signal information, intended for communication with a receiving device, such as the UE 206. In an example, the generated beam may correspond to a directional signal that is transmitted in a direction of the receiving device.

In certain aspects, one or more first antennas among the plurality of antennas 210 may be active for performing the wireless communication with the UE 206. Additionally, or alternatively, one or more second antennas among the plurality of antennas 210 may be inactive while performing the wireless communication. In other words, the one or more second antennas may not contribute to the wireless communication. In some examples, the one or more second antennas may include the remaining antennas of the plurality of antennas 210 that are excluded from the one or more first antennas. In various examples, the one or more first antennas may remain active and the one or more second antennas may remain inactive based on one or more Quality of Service (QoS) policies supported by the DU 202 (and/or the RU 204). For example, the QoS policies may include a network coverage policy, a UE handover policy, an energy-saving policy, or the like. Hereinafter, the one or more first antennas may be referred to as the “first set of active antennas” and the one or more second antennas may be referred to as the “first set of inactive antennas” based on corresponding operational status (e.g., active or inactive). That is to say, the first set of active antennas corresponds to the one or more first antennas among the plurality of antennas 210 that are switched ON, and the first set of inactive antennas corresponds to the one or more second antennas among the plurality of antennas 210 that are switched OFF. For the sake of ongoing discussion, it is assumed that the first set of active antennas may include the first antenna, the second antenna, the sixth antenna, and the seventh antenna. Additionally, the first set of inactive antennas may include the third antenna, the fourth antenna, the fifth antenna, and the eighth antenna.

In the aspects shown in FIG. 2, the message flow 200 may include transmitting a management plane (M-plane) message 212. An M-plane message may be associated with management of an RU. In various aspects, the RU 204 may be configured to transmit the M-plane message 212 to the DU 202. The M-plane message 212 may include a first capability indicator specifying that the RU 204 may support channel estimate information associated with the plurality of antennas 210 in a reduced format. In other words, the DU 202 may be configured to receive the first capability indicator via the M-plane message 212 from the RU 204. The channel estimate information in the reduced format may be independent of one or more inactive antennas of the plurality of antennas 210. In other words, the channel estimate information in the reduced format may not include or be independent of channel estimate information associated with the first set of inactive antennas. In some examples, the M-plane message 212 may further include various configurations associated with the RU 204. In further examples, the M-plane message 212 may be transmitted by the RU 204 based on a power-ON of the RU 204, or restarting of the RU 204.

In an example, the first capability indicator may correspond to a flag in the M-plane message 212. For example, the first capability indicator may indicate a first configured value (e.g., a Boolean value of ‘1’) to specify that the RU 204 may support the channel estimate information associated with the plurality of antennas 210 in the reduced format. Additionally, or alternatively, the first capability indicator may indicate a second configured value (e.g., a Boolean value of ‘0’) to specify that the RU 204 does not support the channel estimate information associated with the plurality of antennas 210 in the reduced format.

In further aspects, the message flow 200 may include receiving a response 214. In various aspects, the RU 204 may be configured to receive the response 214 based on the transmission of the first capability indicator. The response 214 may indicate that the DU 202 may support the channel estimate information in the reduced format. In various examples, the response 214 may correspond to an M-plane message.

In an example, the response 214 may include a second capability indicator. The second capability indicator may correspond to a flag in the response 214. For example, the second capability indicator may indicate a third configured value (e.g., a Boolean value of ‘1’) to specify that the DU 202 may support the channel estimate information associated with the plurality of antennas 210 in the reduced format. Additionally, or alternatively, the second capability indicator may indicate a fourth configured value (e.g., a Boolean value of ‘0’) to specify that the DU 202 does not support the channel estimate information associated with the plurality of antennas 210 in the reduced format.

In furthermore aspects, the message flow 200 may include transmission of an antenna configuration message 216. In various aspects, the DU 202 may be configured to transmit the antenna configuration message 216 associated with the plurality of antennas 210 to the RU 204. In other words, the RU 204 may be configured to receive the antenna configuration message 216 associated with the plurality of antennas 210. In various examples, the antenna configuration message 216 may indicate the first set of active antennas and the first set of inactive antennas, among the plurality of antennas 210.

In an example, the antenna configuration message 216 may correspond to a ST4 message (for example, an ST4 (cmdtype3) message) utilized for configuring or managing the wireless communication. In some more examples, the antenna configuration message 216 may correspond to an M-plane message such as “an mplane-trx-control-ant-mask-update notification”.

In some aspects, to generate the antenna configuration message 216, the DU 202 may be configured to generate a bitmap for the plurality of antennas 210. In some examples, the bitmap may include a plurality of bits for the plurality of antennas 210, respectively. In other words, each bit of the plurality of bits may be mapped to a corresponding antenna of the plurality of antennas 210. The plurality of bits may include a first set of bits, each with a first value (for example, a Boolean value of ‘1’), indicating the first set of active antennas of the plurality of antennas 210. The plurality of bits may further include a second set of bits, each with a second value (for example, a Boolean value of ‘0’), indicating the first set of inactive antennas of the plurality of antennas 210. In other words, each bit of the plurality of bits may have one of the first value indicating that the corresponding antenna is active, or the second value indicating that the corresponding antenna is inactive.

In some more examples, the plurality of bits in the bitmap may be in a specific sequence, and each bit in the bitmap may correspond to a specific antenna among the plurality of antennas 210. The sequence of the plurality of bits in the bitmap may depend on positions of the plurality of antennas 210 in the antenna array 208. For example, the Most Significant Bit (MSB) in the bitmap may correspond to the leftmost antenna in the first row R1 of the antenna array 208 and the Least Significant Bit (LSB) in the bitmap may correspond to the rightmost antenna in a last row (e.g., the second row R2) of the antenna array 208. Mapping between the plurality of antennas 210 and the plurality of bits in the bitmap may follow an order defined by the positions of the plurality of antennas 210 in the antenna array 208.

In a non-limiting example, the bitmap may be denoted as “{1100 0011}” with ‘0’s indicating the first set of inactive antennas (e.g., the third antenna, the fourth antenna, the fifth antenna, and the eighth antenna) and ‘1’s indicating the second set of active antennas (e.g., the first antenna, the second antenna, the sixth antenna, and the seventh antenna). Upon generating the bitmap, the DU 202 may configure the antenna configuration message 216 to include the bitmap. Accordingly, the antenna configuration message 216 may indicate the first set of active antennas and the first set of inactive antennas of the plurality of antennas 210.

In numerous aspects, the message flow 200 may include receiving a first SRS 218. In various aspects, the RU 204 may be configured to receive the first SRS 218 associated with the UE 206. The first SRS 218 may be received from the UE 206. An SRS may indicate characteristics of a communication channel between a UE (for example, the UE 206) and a base station (for example, the DU 202, the RU 204, or a combination of the DU 202 and the RU 204). The characteristics of the communication channel may include path loss, delay spread, Doppler shift, signal-to-noise ratio, interference levels, multipath fading, angle of arrival, angle of departure, channel reciprocity, transmission power requirements, or the like. In various examples, an SRS may be periodically received by the RU 204. In some examples, the first SRS 218 may indicate the characteristics of the channel between the UE 206 and the base station (for example, the DU 202, the RU 204, or the combination of the DU 202 and the RU 204) at a first time instance.

Upon the reception of the first SRS 218, the RU 204 may be configured to generate a first C-plane message 220 based on the first SRS 218 and the antenna configuration message 216. The first C-plane message 220 may indicate a first set of channel estimates for the first set of active antennas of the plurality of antennas 210. Further, a second set of channel estimates for the first set of inactive antennas of the plurality of antennas 210 may be absent in the first C-plane message 220. In some examples, the generation of the first C-plane message 220 may be further based on the response 214. In other words, the RU 204 may generate the first C-plane message 220 in which the first set of channel estimates is present and the second set of channel estimates is absent based on the response 214 indicating that the DU 202 may support the channel estimate information associated with the plurality of antennas 210 in the reduced format. The channel estimate information in the reduced format may exclusively indicate the first set of channel estimates for the first set of active antennas.

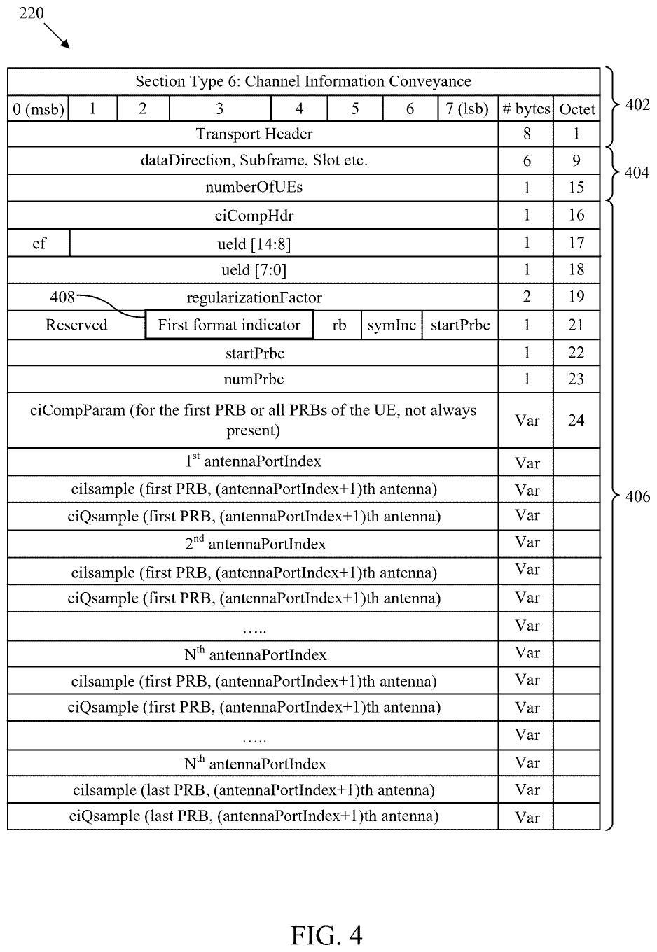

A channel estimate for an antenna of the plurality of antennas 210 may refer to a representation of a current state of a communication channel between the corresponding antenna and the UE 206. In various examples, the first C-plane message 220 may correspond to a Section Type 6 (ST6) message. A structure of the first C-plane message 220 is described in conjunction with FIG. 4. As the second set of channel estimates is absent in the first C-plane message 220, a size of the first C-plane message 220 is reduced in comparison to a C-plane message that includes channel estimate information for the plurality of antennas 210. In certain aspects, the RU 204 may be configured to store the first set of channel estimates in a memory associated with the RU 204.

In some examples, the RU 204 may determine the first set of channel estimates based on various techniques such as Least-Squares (LS) Estimation, Minimum Mean Square Error (MMSE) Estimation, Linear Interpolation/Interpolation-Based Estimation, Time or Frequency Domain Smoothing, Frequency Domain Channel Estimation, or a combination thereof. In further aspects, the first C-plane message 220 may include a first format indicator to specify that the first C-plane message 220 includes the channel estimate information in the reduced format. The channel estimate information in the reduced format may exclusively indicate the first set of channel estimates for the first set of active antennas.

In some aspects, in the first C-plane message 220, each channel estimate of the first set of channel estimates may be associated with an antenna identifier of a corresponding active antenna of the first set of active antennas. In other words, in the first C-plane message 220, an indication that a channel estimate of the first set of channel estimates corresponds to an active antenna of the first set of active antennas may be provided by way of an antenna identifier of the active antenna. For example, a first channel estimate of the first set of channel estimates may be associated with a first antenna identifier of the first antenna in the first C-plane message 220. In some more aspects, the first format indicator in the first C-plane message 220 may further indicate that in the first C-plane message 220, each channel estimate of the first set of channel estimates is associated with the antenna identifier of the corresponding active antenna of the first set of active antennas.

In numerous aspects, each channel estimate of the first set of channel estimates may be associated with a first plurality of physical resource blocks (PRBs) associated with the UE 206. Each channel estimate of the first set of channel estimates may be defined by I (in-phase) and Q (quadrature) components for each PRB of the first plurality of PRBs utilized to control the amplitude and/or phase of the wireless signal associated with the respective antenna of the first set of active antennas. A PRB may correspond to frequency-time resources (comprising subcarriers and time slots) allocated to a UE for data transmission with an RU, a DU, or a combination of the RU and the DU.

The message flow 200 may include transmitting the first C-plane message 220. In various aspects, the RU 204 may be configured to transmit the first C-plane message 220 to the DU 202. In other words, the DU 202 may be configured to receive the first C-plane message 220 from the RU 204. The first C-plane message 220 may be transmitted in the fronthaul interface. As the second set of channel estimates may be absent in the first C-plane message 220, resources utilized for the transmission of the first C-plane message 220 in the fronthaul interface may be reduced in comparison to resources utilized for a transmission of C-plane messages that include channel estimates of both active and inactive antennas. Thus, channel information signaling in the fronthaul interface may be optimized.

Since the second set of channel estimates for the first set of inactive antennas is absent in the first C-plane message 220, the second set of channel estimates for the first set of inactive antennas may not be communicated to the DU 202 over the fronthaul interface. As a result, the overhead in the fronthaul interface may be reduced which in turn enables to improve network performances, such as network latency, network bandwidth, or the like.

The DU 202 may be configured to receive the first C-plane message 220 from the RU 204. As described above, the first C-plane message 220 received by the DU 202 may indicate the first set of channel estimates for the first set of active antennas of the plurality of antennas 210 associated with the RU 204. Further, the second set of channel estimates for the first set of inactive antennas of the plurality of antennas 210 may be absent in the first C-plane message 220. In various aspects, the DU 202 may identify that a channel estimate of the first set of channel estimates is for a corresponding antenna of the plurality of antennas 210 based on the association between the corresponding channel estimate and the corresponding antenna identifier indicated in the first C-plane message 220.

In various examples, the DU 202 may perform at least one of resource allocation, time and frequency domain scheduling, Multiple Input Multiple Output (MIMO) user scheduling, or the like, for the UE 206 based on the first C-plane message 220.

The transmission of the response 214 may assist the RU 204 in identifying whether a DU of the O-RAN architecture 100 supports the channel estimate information associated with the plurality of antennas 210 in the reduced format or not. Accordingly, if the O-RAN architecture 100 includes one or more DUs that do not support the channel estimate information in the reduced format, the transmission of the first capability indicator and the reception of the response 214 may enable the RU 204 to communicate, to the one or more DUs, a third C-plane message that indicates channel estimates for both the first set of active antennas and the first set of inactive antennas. Consequently, the transmission of the first capability indicator and the reception of the response 214, specifying that the DU 202 does not support the channel estimate information in the reduced format, may enable the RU 204 to communicate channel estimates without compromising on the network reliability.

The message flow 200 may include receiving a second SRS 222 associated with the UE 206. In various aspects, the RU 204 may be configured to receive the second SRS 222 associated with the UE 206. The second SRS 222 may be received after the reception of the first SRS 218. In some examples, the second SRS 222 may be received from the UE 206. In some examples, the second SRS 222 may indicate the characteristics of the channel between the UE 206 and the base station (for example, the DU 202, the RU 204, or the combination of the DU 202 and the RU 204) at a second time instance.

Upon the reception of the second SRS 222, the RU 204 may be configured to determine a third set of channel estimates for the first set of active antennas based on the second SRS 222. Further, the RU 204 may be configured to generate a second C-plane message 224 based on the second SRS 222. The second C-plane message 224 may indicate one or more channel estimates of the determined third set of channel estimates. The one or more channel estimates of the determined third set of channel estimates may deviate from corresponding one or more channel estimates of the first set of channel estimates. Additionally, in the second C-plane message 224, at least one channel estimate of the third set of channel estimates that is identical to a corresponding channel estimate of the first set of channel estimates is absent.

In various aspects, the RU 204 may be configured to compare the third set of channel estimates with the first set of channel estimates stored in the memory associated with the RU 204. Further, the second C-plane message 224 may be generated based on the comparison of the third set of channel estimates with the first set of channel estimates. That is to say, the RU 204 may identify the one or more channel estimates of the third set of channel estimates that deviate from the corresponding one or more channel estimates of the first set of channel estimates based on the comparison. Similarly, the RU 204 may identify the at least one channel estimate of the third set of channel estimates that is identical to the corresponding channel estimate of the first set of channel estimates based on the comparison.

In some examples, the one or more channel estimates of the determined third set of channel estimates may deviate from the corresponding one or more channel estimates of the first set of channel estimates beyond a threshold value. In some more examples, the channel estimate of the third set of channel estimates that is identical to the corresponding channel estimate of the first set of channel estimates may correspond to the channel estimate of the third set of channel estimates that deviates from the corresponding channel estimate of the first set of channel estimates below the threshold value.

In some examples, channel estimates of the third set of channel estimates for the second antenna and the seventh antenna may be identical to channel estimates of the first set of channel estimates for the second antenna and the seventh antenna. In such examples, the second C-plane message 224 may include channel estimates of the third set of channel estimates for the first and sixth antennas of the first set of active antennas. Since the second C-plane message 224 does not include the channel estimates that are identical to the corresponding channel estimates in the first C-plane message 220, a size of the second C-plane message 224 is lesser than the size of the first C-plane message 220.

In certain aspects, the second C-plane message 224 may include a composition indicator that may specify that the second C-plane message 224 may not include channel estimates for active antennas whose channel estimates are identical to the corresponding channel estimates in the first C-plane message 220.

The message flow 200 may include transmission of the second C-plane message 224. In various aspects, the RU 204 may be configured to transmit the second C-plane message 224 to the DU 202. As the second C-plane message 224 may not include the channel estimates for active antennas whose channel estimates are identical to the corresponding channel estimates in the first C-plane message 220, the overhead in the fronthaul between the RU 204 and the DU 202 may be further reduced.

In some aspects, the DU 202 may be further configured to receive the second C-plane message 224. In various examples, the DU 202 may perform at least one of resource allocation, time and frequency domain scheduling, Multiple Input Multiple Output (MIMO) user scheduling, or the like, for the UE 206 based on the second C-plane message 224.

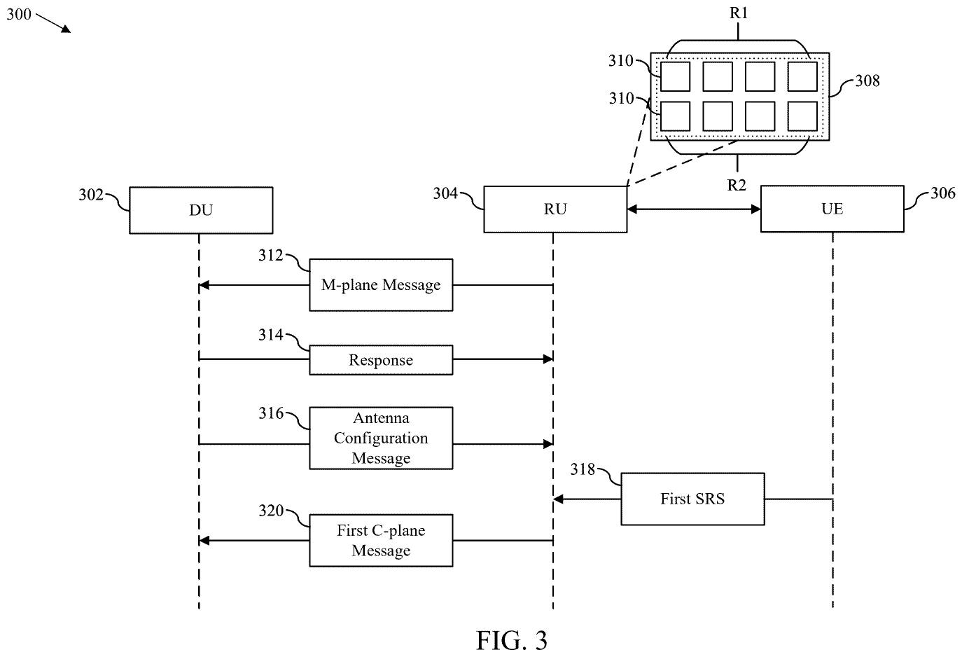

FIG. 3 is a diagram that illustrates an example of a message flow 300 between a DU 302, an RU 304, and a UE 306, in accordance with certain aspects of the present disclosure. The DU 302 may be structurally and functionally similar to the DU 106. Further, the RU 304 may be structurally and functionally similar to the RU 108. Additionally, the UE 306 may be structurally and functionally similar to the UE 110. In various examples, the DU 302 and the RU 304 may be a part of the O-RAN architecture 100.

The RU 304 may be communicatively coupled to the DU 302 via a fronthaul interface (for example, the fronthaul link). As shown in FIG. 3, the RU 304 may be communicatively coupled to the UE 306. Additionally, the RU 304 may be communicatively coupled to at least one antenna array 308. The antenna array 308 may include a plurality of antennas 310. Each antenna of the plurality of antennas 310 may be configured to transmit (and/or receive) at least one wireless signal. Examples of the plurality of antennas 310 may include patch antennas, dipole antennas, or the like, which may be arranged in a linear pattern, a two-dimensional pattern, or a different pattern. In a non-limiting example shown in FIG. 3, the plurality of antennas 310 may include eight antennas, with four antennas being arranged in each of a first row R1 and a second row R2 of the antenna array 308. That is to say, the plurality of antennas 310 may include ninth through sixteenth antennas with the ninth through twelfth antennas being arranged in the first row R1 and the thirteenth through sixteenth antennas being arranged in the second row R2. The antenna array 308 may be integrated within a network node that hosts the RU 304, or alternatively, may be located outside the network node that hosts the RU 304.

In some aspects, the RU 304 may utilize the plurality of antennas 310 to perform wireless communication with the UE 306. In an example, the wireless communication may be performed by forming one or more beams using the plurality of antennas 310. In some examples, the beamforming may involve generating a beam by phase-shifting wireless signals associated with different antennas of the plurality of antennas 310. The generated beam may carry data, such as physical information or reference signal information, intended for communication with a receiving device, such as the UE 306. In an example, the generated beam may correspond to a directional signal that is transmitted in a direction of the receiving device.

In certain aspects, one or more third antennas among the plurality of antennas 310 may be active for performing the wireless communication with the UE 306. Additionally, or alternatively, one or more fourth antennas among the plurality of antennas 310 may be inactive while performing the wireless communication. In other words, the one or more fourth antennas do not contribute to the wireless communication. In some examples, the one or more fourth antennas may include the remaining antennas of the plurality of antennas 310 that are excluded from the one or more third antennas. In various examples, the one or more third antennas may remain active and the one or more fourth antennas may remain inactive based on one or more Quality of Service (QoS) policies supported by the DU 302 (and/or the RU 304). For example, the QoS policies may include a network coverage policy, a UE handover policy, an energy-saving policy, or the like. Hereinafter, the one or more third antennas may be referred to as the “second set of active antennas” and the one or more fourth antennas may be referred to as the “second set of inactive antennas” based on corresponding operational status (e.g., active or inactive). That is to say, the second set of active antennas corresponds to the one or more third antennas among the plurality of antennas 310 that are switched ON, and the second set of inactive antennas corresponds to the one or more fourth antennas among the plurality of antennas 310 that are switched OFF. For the sake of ongoing discussion, it is assumed that the second set of active antennas may include the ninth antenna, the tenth antenna, the fifteenth antenna, and the sixteenth antenna. Additionally, the set of inactive antennas may include the eleventh through fourteenth antennas.

In the aspects shown in FIG. 3, the message flow 300 may include transmitting a management plane (M-plane) message 312. An M-plane message may be associated with management of an RU. In various aspects, the RU 304 may be configured to transmit the M-plane message 312 to the DU 302. The M-plane message 312 may include a third capability indicator specifying that the RU 304 may support channel estimate information associated with the plurality of antennas 310 in a reduced format. In other words, the DU 302 may be configured to receive the third capability indicator via the M-plane message 312 from the RU 304. The channel estimate information in the reduced format may be independent of one or more inactive antennas of the plurality of antennas 310. In other words, the channel estimate information in the reduced format may not include channel estimate information associated with the second set of inactive antennas. In some examples, the M-plane message 312 may further include various configurations associated with the RU 304. In further examples, the M-plane message 312 may be transmitted by the RU 304 based on a power-ON of the RU 304, or restarting of the RU 304.

In an example, the third capability indicator may correspond to a flag in the M-plane message 312. For example, the third capability indicator may indicate a fifth configured value (e.g., a Boolean value of ‘1’) to specify that the RU 304 may support the channel estimate information associated with the plurality of antennas 310 in the reduced format. Additionally, or alternatively, the third capability indicator may indicate a sixth configured value (e.g., a Boolean value of ‘0’) to specify that the RU 304 does not support the channel estimate information associated with the plurality of antennas 310 in the reduced format.

In further aspects, the message flow 300 may include receiving a response 314. In various aspects, the RU 304 may be configured to receive the response 314 based on the transmission of the third capability indicator. The response 314 may indicate that the DU 302 may support the channel estimate information in the reduced format. In various examples, the response 314 may correspond to an M-plane message.

In an example, the response 314 may include a fourth capability indicator. The fourth capability indicator may correspond to a flag in the response 314. For example, the fourth capability indicator may indicate a seventh configured value (e.g., a Boolean value of ‘1’) to specify that the DU 302 may support the channel estimate information associated with the plurality of antennas 310 in the reduced format. Additionally, or alternatively, the fourth capability indicator may indicate an eighth configured value (e.g., a Boolean value of ‘0’) to specify that the DU 302 does not support the channel estimate information associated with the plurality of antennas 310 in the reduced format.

In furthermore aspects, the message flow 300 may include transmission of an antenna configuration message 316. In various aspects, the DU 302 may be configured to transmit the antenna configuration message 316 associated with the plurality of antennas 310 to the RU 304. In other words, the RU 304 may be configured to receive the antenna configuration message 316 associated with the plurality of antennas 310. In various examples, the antenna configuration message 316 may indicate the second set of active antennas and the second set of inactive antennas, among the plurality of antennas 310.

In an example, the antenna configuration message 316 may correspond to a Section Type 4 (ST4) message (for example, an ST4 (cmdtype3) message) utilized for configuring or managing the wireless communication. In some more examples, the antenna configuration message 316 may correspond to an M-plane message such as “an mplane-trx-control-ant-mask-update notification”.

In some aspects, to generate the antenna configuration message 316, the DU 302 may be configured to generate a bitmap for the plurality of antennas 310. In some examples, the bitmap may include a plurality of bits for the plurality of antennas 310, respectively. In other words, each bit of the plurality of bits may be mapped to a corresponding antenna of the plurality of antennas 310. The plurality of bits may include a third set of bits, each with a third value (for example, a Boolean value of ‘1’), indicating the second set of active antennas of the plurality of antennas 310. The plurality of bits may further include a fourth set of bits, each with a fourth value (for example, a Boolean value of ‘0’), indicating the second set of inactive antennas of the plurality of antennas 310. In other words, each bit of the plurality of bits may have one of the third value indicating that the corresponding antenna is active, or the fourth value indicating that the corresponding antenna is inactive.

In some more examples, the plurality of bits in the bitmap may be in a specific sequence, and each bit in the bitmap may correspond to a specific antenna among the plurality of antennas 310. The sequence of the plurality of bits in the bitmap may depend on positions of the plurality of antennas 310 in the antenna array 308. For example, the Most Significant Bit (MSB) in the bitmap may correspond to the leftmost antenna in the first row R1 of the antenna array 308 and the Least Significant Bit (LSB) in the bitmap may correspond to the rightmost antenna in a last row (e.g., the second row R2) of the antenna array 308. Mapping between the plurality of antennas 310 and the plurality of bits in the bitmap may follow an order defined by the positions of the plurality of antennas 310 in the antenna array 308.

In a non-limiting example, the bitmap may be denoted as “{1100 0011}” with ‘0’s indicating the second set of inactive antennas (e.g., the eleventh through fourteenth antennas) and ‘1’s indicating the second set of active antennas (e.g., the ninth antenna, the tenth antenna, the fifteenth antenna, and the sixteenth antenna). Upon generating the bitmap, the DU 302 may configure the antenna configuration message 316 to include the bitmap. Accordingly, the antenna configuration message 316 may indicate the second set of active antennas and the second set of inactive antennas of the plurality of antennas 310.

In further aspects, the message flow 300 may include receiving a first SRS 318. In various aspects, the RU 304 may be configured to receive the first SRS 318 associated with the UE 306. In some examples, the RU 304 may receive the first SRS 318 from the UE 306. An SRS may indicate characteristics of a communication channel between a UE (for example, the UE 306) and a base station (for example, the DU 302, the RU 304, or a combination of the DU 302 and the RU 304). The characteristics of the communication channel may include path loss, delay spread, Doppler shift, signal-to-noise ratio, interference levels, multipath fading, angle of arrival, angle of departure, channel reciprocity, transmission power requirements, or the like.

Upon the reception of the first SRS 318, the RU 304 may be configured to generate a first C-plane message 320 based on the first SRS 318 and the antenna configuration message 316. The first C-plane message 320 may indicate a fourth set of channel estimates for the second set of active antennas of the plurality of antennas 310. Further, a fifth set of channel estimates for the second set of inactive antennas of the plurality of antennas 310 may be absent in the first C-plane message 320. In some examples, the generation of the first C-plane message 320 may be further based on the fourth capability indicator received via the response 314. That is to say, the RU 304 may generate the first C-plane message 320 in which the fourth set of channel estimates is present and the fifth set of channel estimates is absent based on the fourth capability indicator specifying that the DU 302 may support the channel estimate information associated with the plurality of antennas 310 in the reduced format. The channel estimate information in the reduced format exclusively indicates the fourth set of channel estimates for the second set of active antennas.

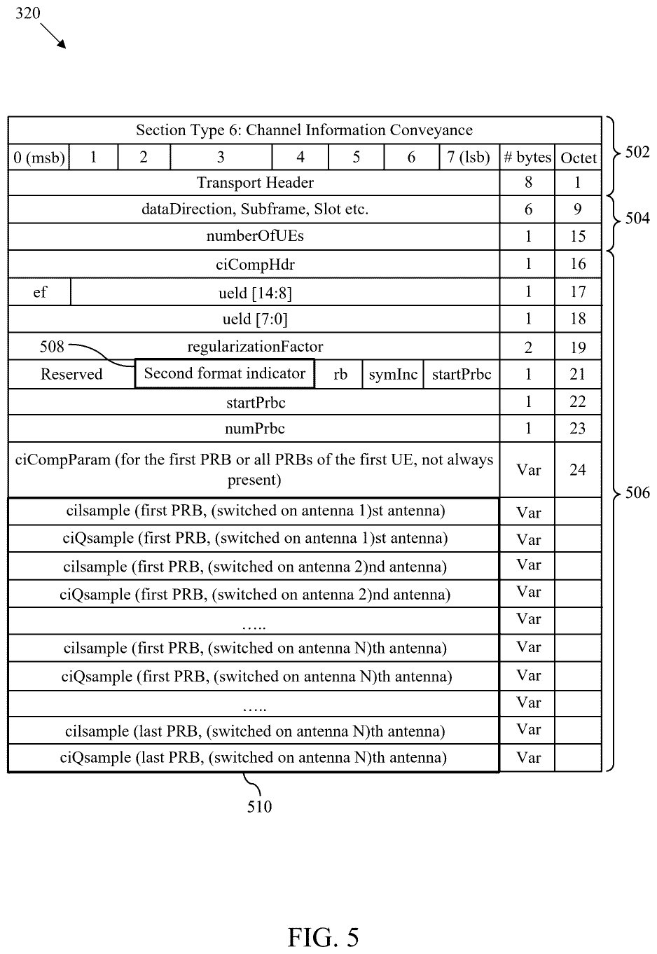

A channel estimate for an antenna of the plurality of antennas 310 may refer to a representation of a current state of a communication channel between the corresponding antenna and the UE 306. In various examples, the first C-plane message 320 may correspond to an ST6 message. A structure of the first C-plane message 320 is described in conjunction with FIG. 5. As the fifth set of channel estimates is absent in the first C-plane message 320, a size of the first C-plane message 320 is reduced in comparison to a conventional C-plane message that includes channel estimate information for the plurality of antennas 310.

In some examples, the RU 304 may determine the fourth set of channel estimates based on various techniques such as the LS Estimation, the MMSE Estimation, the Linear Interpolation/Interpolation-Based Estimation, the Time or Frequency Domain Smoothing, the Frequency Domain Channel Estimation, or a combination thereof.

In some examples, in the first C-plane message 320, the fourth set of channel estimates for the second set of active antennas may be indicated in a same sequence in which the second set of active antennas is indicated in the bitmap of the antenna configuration message 316. In other words, in the first C-plane message 320, occurrences of the fourth set of channel estimates may follow the same sequence in which the second set of active antennas is indicated in the antenna configuration message 316. For example, if the ninth antenna is indicated prior to the tenth antenna in the antenna configuration message 316, an occurrence of the channel estimate for the ninth antenna may also be prior to an occurrence of the channel estimate for the tenth antenna in the first C-plane message 320. In the aspects described in FIG. 3, the fourth set of channel estimates in the first C-plane message 320 may be denoted in a sequence such as “{0.72, 0.76; 0.94, 0.92; 0.82, 0.84; 0.86, 0.88}” with ‘0.72, 0.76’ being the channel estimate of the ninth antenna, ‘0.94, 0.92’ being the channel estimate of the tenth antenna, ‘0.82, 0.84’ being the channel estimate of the fifteenth antenna, and ‘0.86, 0.88’ being the channel estimate of the sixteenth antenna.

In various aspects, the first C-plane message 320 may include a second format indicator that may specify that the first C-plane message 320 may include the channel estimate information for the plurality of antennas 310 in the reduced format. In some examples, the channel estimate information in the reduced format may exclusively indicate the fourth set of channel estimates for the second set of active antennas. In further aspects, the second format indicator may further specify that the fourth set of channel estimates is in a same sequence as the second set of active antennas in the antenna configuration message 316.

In numerous aspects, each channel estimate of the fourth set of channel estimates may be associated with a second plurality of PRBs associated with the UE 306. That is to say, each channel estimate of the fourth set of channel estimates may be defined by I (in-phase) and Q (quadrature) components for each PRB of the second plurality of PRBs.

The message flow 300 may include transmitting the first C-plane message 320. In various aspects, the RU 304 may be configured to transmit the first C-plane message 320 to the DU 302. In other words, the DU 302 may be configured to receive the first C-plane message 320 from the RU 304. In various examples, the first C-plane message 320 may be transmitted via the fronthaul interface. As the fifth set of channel estimates may be absent in the first C-plane message 320, resources utilized for the transmission of the first C-plane message 320 in the fronthaul interface may be reduced in comparison to resources utilized for transmission of the conventional C-plane message. Thus, channel information signaling in the fronthaul interface may be optimized.

Since the fifth set of channel estimates for the second set of inactive antennas is absent in the first C-plane message 320, the fifth set of channel estimates for the second set of inactive antennas may not be communicated to the DU 302 over the fronthaul interface. As a result, the overhead in the fronthaul interface may be reduced which in turn enables to improve network performances, such as network latency, network bandwidth, or the like.

The DU 302 may be configured to receive the first C-plane message 320 from the RU 304. As described above, the first C-plane message 320 received by the DU 302 may indicate the fourth set of channel estimates for the second set of active antennas of the plurality of antennas 310. Further, the fifth set of channel estimates for the second set of inactive antennas of the plurality of antennas 310 may be absent in the first C-plane message 320. In various aspects, the DU 302 may identify that a channel estimate of the fourth set of channel estimates is for a corresponding antenna of the plurality of antennas 310 based on the sequence of the second set of active antennas in the antenna configuration message 316.

In various examples, the DU 302 may perform at least one of resource allocation, time and frequency domain scheduling, Multiple Input Multiple Output (MIMO) user scheduling, or the like, for the UE 306 based on the first C-plane message 320.

The transmission of the response 314 may assist the RU 304 in identifying whether a DU of the O-RAN architecture 100 supports the channel estimate information associated with the plurality of antennas 310 in the reduced format or not. Accordingly, if the O-RAN architecture 100 includes one or more DUs that do not support the channel estimate information in the reduced format, the transmission of the third capability indicator and the reception of the response 314 may enable the RU 304 to communicate, to the one or more DUs, a third C-plane message that indicates channel estimates for both the second set of active antennas and the second set of inactive antennas. Consequently, the transmission of the third capability indicator and the reception of the response 314, specifying that the DU 302 does not support the channel estimate information in the reduced format, may enable the RU 304 to communicate channel estimates without compromising on the network reliability.

FIG. 4 is a diagram that illustrates an example of the first C-plane message 220, in accordance with certain aspects of the present disclosure. FIG. 4 is explained in conjunction with FIGS. 1 and 2. In numerous examples, the first C-plane message 220 may be transmitted from the RU 204 to the DU 202.

As shown in FIG. 4, the first C-plane message 220 may include a transport header section 402, a common header 404, and section information 406. The transport header section 402 may include a header field that indicates the first C-plane message 220 as the ST6 message for channel information conveyance. The transport header section 402 may further include a transport header. The transport header may indicate information related to the first C-plane message 220, such as a message type, transmission source identifier(s), destination identifier(s), sequence number identifier(s), or the like. For example, the transport header may correspond to an enhanced Common Public Radio Interface (eCPRI) transport header or Institute of Electrical and Electronics Engineers (IEEE) transport header.

The common header 404 may include a dataDirection field, a payloadVersion field, a filterIndex (filter index) field, a frameId (frame identifier) field, a subframeId (subframe identifier) field, a slotID (slot identifier) field, a startSymbolid (start symbol identifier) field, a numberOfsections (number of sections) field, sectionType (section type) field with value=6, a numberOfUEs (number of UE-specific channel information data sets) field, and a reserved (reserved for future use) field.

The section information 406 may be configured for the UE 206. In various aspects, the section information 406 may optionally include ciCompHdr (channel information compression header) field. The ciCompHdr may hold metadata or header information related to a specific component in the first C-plane message 220. The section information 406 may further include an ef (extension flag) field, a ueId (UE identifier) field, a regularizationFactor (regularization factor used for MMSE) field, a reserved (reserved for future use) field, an rb (resource block identifier) field, a symInc (symbol number increment command) field, a startPrbc (starting PRB of data section description) field, and a numPrbc (number of contiguous PRBs per data section description) field. The section information 406 may optionally include ciCompParam (channel information compression parameter) field.

Referring to the example described in FIG. 2 where the first set of active antennas includes the first antenna, the second antenna, the sixth antenna, and the seventh antenna, the section information 406 may further include the first antenna identifier (denoted as 1st antennaPortIndex) of the first antenna, a second antenna identifier (denoted as 2nd antennaPortIndex) of the second antenna, a sixth antenna identifier (not shown) of the sixth antenna and a seventh antenna identifier (denoted as Nth antennaPortIndex) of the seventh antenna.

The section information 406 may further include the first set of channel estimates for the first set of active antennas. In reference to the example described in FIG. 2, the first set of channel estimates may include the first channel estimate for the first antenna, a second channel estimate for the second antenna, a sixth channel estimate for the sixth antenna, and a seventh channel estimate for the seventh antenna. Further, each channel estimate of the first set of channel estimates may include IQ data for each PRB of the first plurality of PRBs.

The first set of channel estimates associated with the first plurality of PRBs may be denoted as cilsample (first PRB, (antennaPortIndex+1)th antenna) and ciQsample (first PRB, (antennaPortIndex+1)th antenna), cilsample (first PRB, (antennaPortIndex+1)th antenna) and ciQsample (first PRB, (antennaPortIndex+1)th antenna), . . . , cilsample (first PRB, (antennaPortIndex+1)th antenna) and ciQsample (first PRB, (antennaPortIndex+1)th antenna), and cilsample (last PRB, (antennaPortIndex+1)th antenna) and ciQsample (last PRB, (antennaPortIndex+1)th antenna) in the section information 406.

In further aspects, the first C-plane message 220 may include the first format indicator 408 to specify whether the first C-plane message 220 includes the channel estimate information in the reduced format. The channel estimate information in the reduced format may exclusively indicate the first set of channel estimates for the first set of active antennas. In an example, the first format indicator 408 may correspond to the flag in the first C-plane message 220. The first format indicator 408 may indicate the first configured value (e.g., the Boolean value of ‘1’) to specify that the first C-plane message 220 includes the channel estimate information in the reduced format. Additionally, or alternatively, the first format indicator 408 may indicate the second configured value (e.g., the Boolean value of ‘0’) to specify that the first C-plane message 220 does not comprise the channel estimate information in the reduced format.

In some examples, the first format indicator 408 in the first C-plane message 220 may further indicate that in the first C-plane message 220, each channel estimate of the first set of channel estimates is associated with the antenna identifier of the corresponding active antenna of the first set of active antennas. That is to say, the first format indicator 408 may indicate the first configured value (e.g., the Boolean value of ‘1’) to indicate that each channel estimate of the first set of channel estimates is associated with the antenna identifier of the corresponding active antenna of the first set of active antennas.

FIG. 5 is a diagram that illustrates an example of the first C-plane message 320, in accordance with certain aspects of the present disclosure. FIG. 5 is explained in conjunction with FIGS. 1 and 3. In numerous examples, the first C-plane message 320 may be transmitted from the RU 304 to the DU 302.

As shown in FIG. 5, the first C-plane message 320 may include a transport header section 502, a common header 504, and section information 506. The transport header section 502 may be similar to the transport header section 402. Further, the common header 504 may be similar to the common header 404.

The section information 506 may be configured for the UE 306. In various aspects, the section information 506 may optionally include ciCompHdr (channel information compression header) field. The ciCompHdr may hold metadata or header information related to a specific component in the first C-plane message 320. The section information 506 may further include an ef (extension flag) field, a ueId (UE identifier) field, a regularizationFactor (regularization factor used for MMSE) field, a reserved (reserved for future use) field, an rb (resource block identifier) field, a symInc (symbol number increment command) field, a startPrbc (starting PRB of data section description) field, and a numPrbc (number of contiguous PRBs per data section description) field. The section information 506 may optionally include ciCompParam (channel information compression parameter) field.

In numerous aspects, the first C-plane message 320 may include the second format indicator 508 to specify whether the first C-plane message 320 includes the channel estimate information in the reduced format. The channel estimate information in the reduced format may exclusively indicate the fourth set of channel estimates for the second set of active antennas. In an example, the second format indicator 508 may correspond to the flag in the first C-plane message 320. The first C-plane message 320 may indicate the third configured value (e.g., the Boolean value of ‘1’) to specify that the first C-plane message 320 includes the channel estimate information in the reduced format. Additionally, or alternatively, the second format indicator 508 may indicate the fourth configured value (e.g., the Boolean value of ‘0’) to specify that the first C-plane message 320 does not comprise the channel estimate information in the reduced format. In some examples, the second format indicator 508 may further specify that the fourth set of channel estimates is in a same sequence as the second set of active antennas in the antenna configuration message 316.

In various aspects, the section information 506 may include the fourth set of channel estimates 510 for the second set of active antennas. Each channel estimate of the fourth set of channel estimates 510 may include IQ data for each PRB of the second plurality of PRBs.

The fourth set of channel estimates 510 associated with the second plurality of PRBs may be denoted as cilsample (first PRB, (switched on antenna 1st antenna) and ciQsample (first PRB, (switched on antenna 1st antenna), cilsample (first PRB, (switched on antenna 2nd antenna) and ciQsample (first PRB, (switched on antenna 2nd antenna), . . . , cilsample (first PRB, switched on antenna Nth antenna) and ciQsample (first PRB, switched on antenna Nth antenna), and cilsample (last PRB, (switched on antenna Nth antenna) and ciQsample (last PRB, (switched on antenna Nth antenna) in the section information 506.

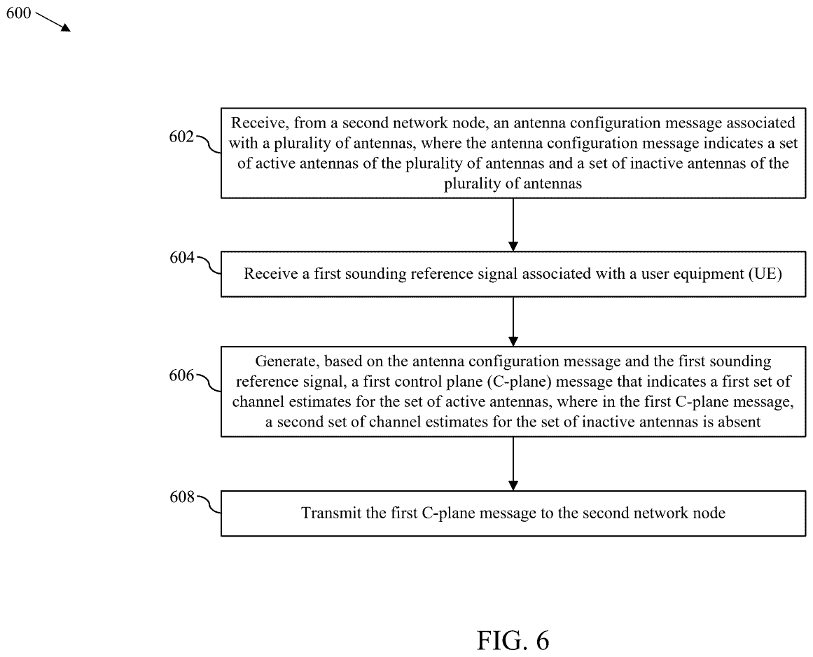

FIG. 6 is a diagram that illustrates a high-level flowchart for a process (e.g., a method) 600 for wireless communication, in accordance with certain aspects of the present disclosure. FIG. 6 is explained in conjunction with FIGS. 1-5. In various examples, the process 600 may be implemented by a first network node to enable wireless communication. The first network node may correspond to at least one of the RU 108, the RU 204, or the RU 304 in FIG. 6. Further, a UE described in FIG. 6 may correspond to at least one of the UE 110, UE 206, or the UE 306. A second network node described in FIG. 6 may correspond to at least one of the DU 106, the DU 202, or the DU 302.

At 602, an antenna configuration message (for example, the antenna configuration message 216 or the antenna configuration message 316) associated with a plurality of antennas (for example, the plurality of antennas 210 or the plurality of antennas 310) may be received. The antenna configuration message may indicate a set of active antennas (for example, the first set of active antennas or the second set of active antennas) of the plurality of antennas and a set of inactive antennas (for example, the first set of inactive antennas or the second set of inactive antennas) of the plurality of antennas. In numerous examples, the first network node may receive the antenna configuration message from the second network node.

At 604, a first SRS (for example, the first SRS 218 or the first SRS 318) associated with the UE may be received. In numerous examples, the first network node may receive the first SRS from the UE. The first SRS may indicate characteristics of a communication channel between the UE and a base station (for example, the first network node, the second network node, or a combination of the first network node and the second network node).

At 606, a first C-plane message (for example, the first C-plane message 220 or the first C-plane message 320) may be generated based on the antenna configuration message and the first SRS. The first C-plane message may indicate a set of channel estimates (for example, the first set of channel estimates or the fourth set of channel estimates) for the set of active antennas (for example, the first set of active antennas or the second set of active antennas). Further, in the first C-plane message, a set of channel estimates (for example, the second set of channel estimates or the fifth set of channel estimates) for the set of inactive antennas (for example, the first set of inactive antennas or the second set of inactive antennas) may be absent. In some aspects, the first C-plane message may be generated by the first network node. In some examples, the first C-plane message may correspond to the ST6 message.

At 608, the first C-plane message may be transmitted to the second network node. In numerous examples, the first C-plane message may be transmitted by the first network node to the second network node via the fronthaul interface.

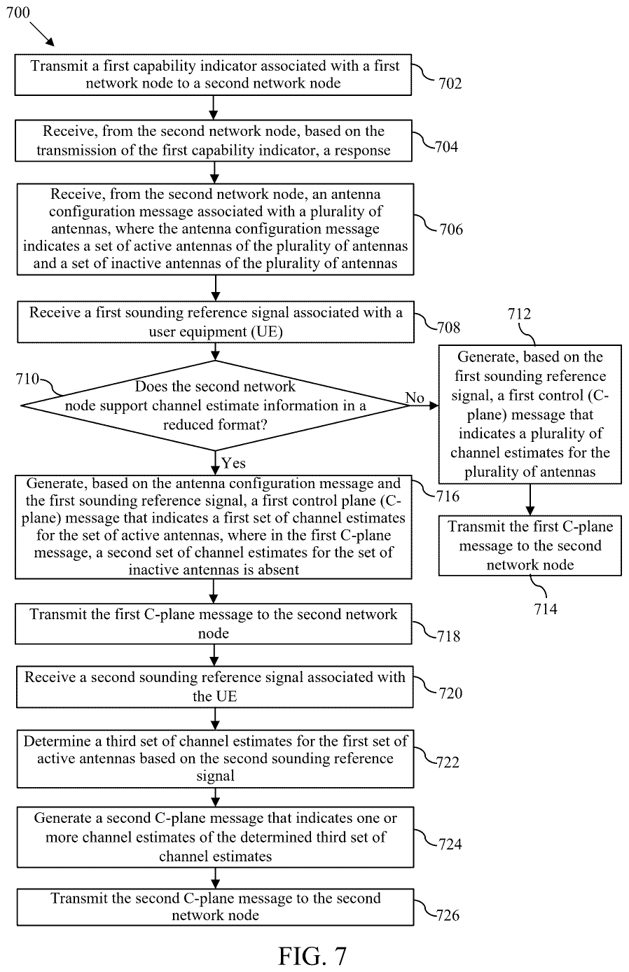

FIG. 7 is a diagram that illustrates a flowchart for a process (e.g., a method) 700 for the wireless communication, in accordance with certain aspects of the present disclosure. FIG. 7 is explained in conjunction with FIGS. 1, 2, and 4. In various examples, the process 700 may be implemented by a first network node to enable wireless communication. The first network node may correspond to the RU 204 in FIG. 7. A second network node described in FIG. 7 may correspond to the DU 202.

At 702, the first capability indicator associated with the first network node may be transmitted to the second network node. The first capability indicator may be transmitted by the first network node. In various examples, the first capability indicator may be transmitted via the M-plane message 212. In some more examples, the first capability indicator may correspond to the flag in the M-plane message 212. For example, the first capability indicator may indicate the first configured value (e.g., the Boolean value of ‘1’) to specify that the RU 204 supports the channel estimate information for the plurality of antennas 210 in the reduced format. Additionally, or alternatively, the first capability indicator may indicate the second configured value (e.g., the Boolean value of ‘0’) to specify that the RU 204 does not support the channel estimate information for the plurality of antennas 210 in the reduced format.

At 704, the response 214 may be received from the second network node based on the transmission of the first capability indicator. The response 214 may indicate that the second network node may support the channel estimate information in the reduced format. In various examples, the response 214 may correspond to an M-plane message.

At 706, the antenna configuration message 216 associated with the plurality of antennas 210 may be received from the second network node. The antenna configuration message 216 may indicate the first set of active antennas of the plurality of antennas 210 and the first set of inactive antennas of the plurality of antennas 210. In various examples, the antenna configuration message 216 may be received by the first network node.

At 708, the first SRS 218 associated with the UE 206 may be received. In some examples, the first SRS 218 may be received by the first network node. In various examples, the first SRS 218 may be received from the UE 206. The first SRS 218 may indicate the characteristics of the channel between the UE 206 and the base station (for example, the DU 202, the RU 204, or the combination of the DU 202 and the RU 204) at the first time instance.

At 710, a determination of whether the second network node supports the channel estimate information in the reduced format may be performed. In numerous examples, the first network node may perform the determination based on the response 214. In further examples, the determination may be performed by the first network node upon the reception of the first SRS 218.

In some aspects, if the first network node determines that the second network node does not support the channel estimate information in the reduced format, a first C-plane message that indicates a plurality of channel estimates for the plurality of antennas 210 may be generated based on the first SRS 218 at 712. The first C-plane message may be generated by the first network node. At 714, the first C-plane message generated at 712 may be transmitted to the second network node. In some examples, the first C-plane message may be transmitted to the second network node by the first network node. The first C-plane message may correspond to the ST6 message.

In further aspects, if the first network node determines that the second network node supports the channel estimate information in the reduced format, the first C-plane message 220 may be generated based on the antenna configuration message 216 and the first SRS 218 at 716. The first C-plane message 220 may indicate the first set of channel estimates for the first set of active antennas of the plurality of antennas 210. Further, in the first C-plane message 220, the second set of channel estimates for the first set of inactive of the plurality of antennas 210 may be absent. In some examples, the first C-plane message 220 may be generated by the first network node. In numerous examples, the first C-plane message 220 may correspond to the ST6 message.

In some aspects, in the first C-plane message 220, each channel estimate of the first set of channel estimates may be associated with the antenna identifier of the corresponding active antenna of the first set of active antennas. In other words, in the first C-plane message 220, an indication that a channel estimate of the first set of channel estimates corresponds to an active antenna of the first set of active antennas may be provided by way of an antenna identifier of the active antenna.

At 718, the first C-plane message 220 may be transmitted to the second network node. In various examples, the first C-plane message 220 may be transmitted to the second network node by the first network node. In numerous examples, the first C-plane message 220 may be transmitted to the second network node by the first network node via the fronthaul interface.

At 720, the second SRS 222 associated with the UE 206 may be received. The second SRS 222 may be received after the reception of the first SRS 218. In some examples, the second SRS 222 may be received by the first network node. The second SRS 222 may indicate the characteristics of the channel between the UE 206 and the base station (for example, the DU 202, the RU 204, or the combination of the DU 202 and the RU 204) at the second time instance.

At 722, the third set of channel estimates for the first set of active antennas may be determined based on the second SRS 222. In some examples, the third set of channel estimates for the first set of active antennas may be determined by the first network node. At 724, the second C-plane message 224 that indicates the one or more channel estimates of the determined third set of channel estimates may be generated. In some examples, the second C-plane message 224 may be generated by the first network node. The one or more channel estimates of the determined third set of channel estimates may deviate from corresponding one or more channel estimates of the first set of channel estimates. Additionally, in the second C-plane message 224, at least one channel estimate of the third set of channel estimates that is identical to a corresponding channel estimate of the first set of channel estimates may be absent. In numerous examples, the second C-plane message 224 may correspond to the ST6 message.

At 726, the second C-plane message 224 may be transmitted to the second network node. In some examples, the second C-plane message 224 may be transmitted to the second network node by the first network node. In numerous examples, the second C-plane message 224 may be transmitted to the second network node from the first network node via the fronthaul interface.

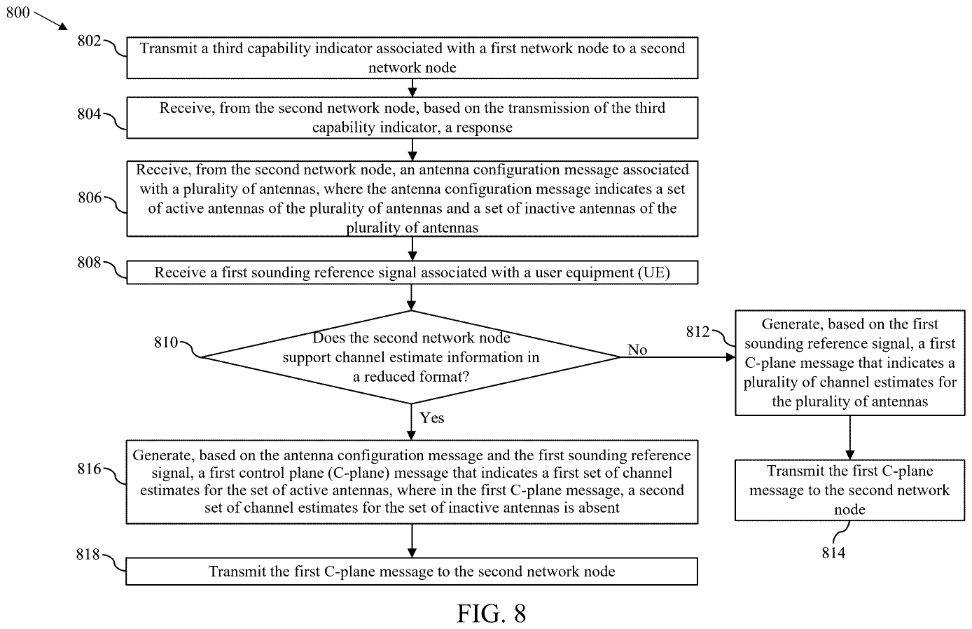

FIG. 8 is a diagram that illustrates a flowchart for a process (e.g., a method) 800 for the wireless communication, in accordance with certain aspects of the present disclosure. FIG. 8 is explained in conjunction with FIGS. 1, 3, and 5. In various examples, the process 800 may be implemented by a first network node to enable wireless communication. The first network node may correspond to the RU 304 in FIG. 8. A second network node described in FIG. 8 may correspond to the DU 302.

At 802, the third capability indicator associated with the first network node may be transmitted to the second network node. The third capability indicator may be transmitted by the first network node. In various examples, the third capability indicator may be transmitted via the M-plane message 312. In some more examples, the third capability indicator may correspond to the flag in the M-plane message 312. For example, the third capability indicator may indicate the fifth configured value (e.g., a Boolean value of ‘1’) to specify that the first network node may support the channel estimate information associated with the plurality of antennas 310 in the reduced format. Additionally, or alternatively, the third capability indicator may indicate the sixth configured value (e.g., a Boolean value of ‘0’) to specify that the first network node does not support the channel estimate information associated with the plurality of antennas 310 in the reduced format.

At 804, the response 314 may be received from the second network node based on the transmission of the third capability indicator. The response 314 may indicate that the second network node may support the channel estimate information in the reduced format. In various examples, the response 314 may correspond to an M-plane message.

At 806, the antenna configuration message 316 associated with the plurality of antennas 310 may be received from the second network node. The antenna configuration message 316 may indicate the second set of active antennas of the plurality of antennas 310 and the second set of inactive antennas of the plurality of antennas 310. In various examples, the antenna configuration message 316 may be received by the first network node.

At 808, the first SRS 318 associated with the UE 306 may be received. In some examples, the first SRS 318 may be received by the first network node. In various examples, the first SRS 318 may be received from the UE 306. The first SRS 318 may indicate the characteristics of the channel between the UE 306 and the base station (for example, the DU 302, the RU 304, or the combination of the DU 302 and the RU 304).

At 810, a determination of whether the second network node supports the channel estimate information in the reduced format may be performed. In numerous examples, the first network node may perform the determination based on the response 314. In further examples, the determination may be performed by the first network node upon the reception of the first SRS 318.

In some aspects, if the first network node determines that the second network node does not support the channel estimate information in the reduced format, a first C-plane message that indicates a plurality of channel estimates for the plurality of antennas 310 may be generated based on the first SRS 318 at 812. The first C-plane message may be generated by the first network node. At 814, the first C-plane message generated at 812 may be transmitted to the second network node. In some examples, the first C-plane message may be transmitted to the second network node by the first network node. The first C-plane message may correspond to the ST6 message.

In further aspects, if the first network node determines that the second network node supports the channel estimate information in the reduced format, the first C-plane message 320 may be generated based on the antenna configuration message 316 and the first SRS 318 at 816. The first C-plane message 320 may indicate the fourth set of channel estimates for the second set of active antennas of the plurality of antennas 310. Further, in the first C-plane message 320, the fifth set of channel estimates for the second set of inactive antennas of the plurality of antennas 310 may be absent. In some examples, the first C-plane message 320 may be generated by the first network node. In numerous examples, the first C-plane message 320 may correspond to the ST6 message.

In some examples, in the first C-plane message 320, the fourth set of channel estimates for the second set of active antennas may be indicated in the same sequence in which the second set of active antennas is indicated in the bitmap of the antenna configuration message 316.

At 818, the first C-plane message 320 may be transmitted to the second network node. In various examples, the first C-plane message 320 may be transmitted to the second network node by the first network node. In numerous examples, the first C-plane message 320 may be transmitted to the second network node by the first network node via the fronthaul interface.

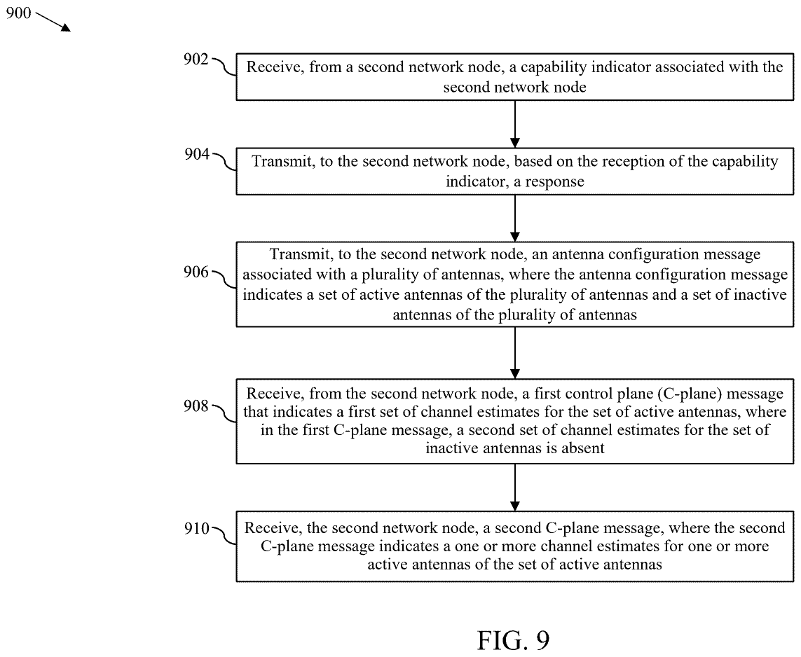

FIG. 9 is a diagram that illustrates a flowchart for a process (e.g., a method) 900 for the wireless communication, in accordance with certain aspects of the present disclosure. FIG. 9 is explained in conjunction with FIG. 1-5.

In various examples, the process 900 may be implemented by a first network node to enable wireless communication. The first network node may correspond to at least one of the DU 106, the DU 202, or the DU 302 in FIG. 6. Further, a UE described in FIG. 9 may correspond to at least one of the UE 110, UE 206, or the UE 306. A second network node described in FIG. 9 may correspond to at least one of the RU 108, the RU

### 204, or the Ru 304.

At 902, a capability indicator (for example, the first capability indicator or the second capability indicator) associated with the second network node may be received from the second network node. In various examples, the capability indicator may be received by the first network node from the second network node via an M-plane message (for example, the M-plane message 212 or the M-plane message 312). In some examples, the capability indicator may specify whether the second network node supports channel estimate information associated with a plurality of antennas in a reduced format. In FIG. 9, the plurality of antennas may correspond to at least one of the plurality of antennas 210 or the plurality of antennas 310.

At 904, a response (for example, the response 214 or the response 314) may be transmitted to the second network node based on the reception of the capability indicator. The response may indicate that the second network node may support the channel estimate information in the reduced format. In various examples, the response may correspond to an M-plane message.

At 906, an antenna configuration message (for example, the antenna configuration message 216 or the antenna configuration message 316) associated with a plurality of antennas (for example, the plurality of antennas 210 or the plurality of antennas 310) may be transmitted to the second network node. The antenna configuration message may indicate a set of active antennas (for example, the first set of active antennas or the second set of active antennas) of the plurality of antennas and a set of inactive antennas (for example, the first set of inactive antennas or the second set of inactive antennas) of the plurality of antennas. In numerous examples, the first network node may transmit the antenna configuration message to the second network node.

At 908, a first C-plane message (for example, the first C-plane message 220 or the first C-plane message 320) may be received from the second network node. The first C-plane message may indicate a set of channel estimates (for example, the first set of channel estimates or the fourth set of channel estimates) for the set of active antennas (for example, the first set of active antennas or the second set of active antennas). Further, in the first C-plane message, a set of channel estimates (for example, the second set of channel estimates or the fifth set of channel estimates) for the set of inactive antennas (for example, the first set of inactive antennas or the second set of inactive antennas) may be absent. In some aspects, the first C-plane message may be received by the first network node. In some examples, the first C-plane message may correspond to the ST6 message. In numerous examples, the first C-plane message may be received by the first network node from the second network node via the fronthaul interface.

At 910, a second C-plane message (for example, the second C-plane message 224) may be received from the second network node. The second C-plane message may indicate one or more channel estimates for one or more active antennas for the set of active antennas. The one or more channel estimates may deviate from corresponding one or more channel estimates of the first set of channel estimates. In the second C-plane message, at least one channel estimate of at least one active antenna of the set of active antennas may be absent.

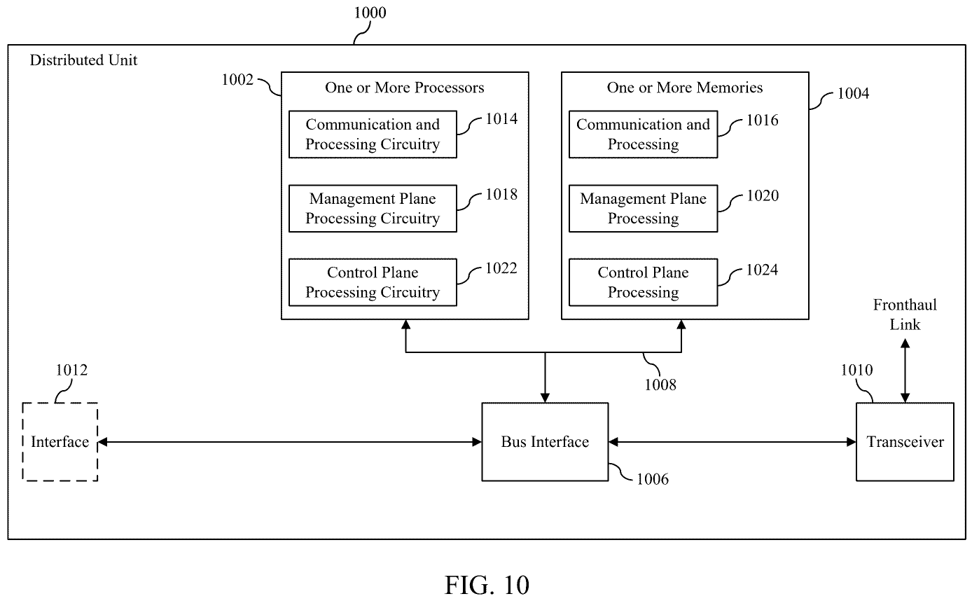

FIG. 10 is a diagram that illustrates an example of a DU 1000, in accordance with certain aspects of the present disclosure. FIG. 10 is explained in conjunction with FIGS. 1-9. The DU 1000 may enable wireless communication with an RU and/or one or more communication devices. In some examples, the DU 1000 may correspond to the NR base station, the LTE base station, the eNB, the gNB, the access point, the TRP, or the like.

In some aspects, the DU 1000 may include one or more processors 1002, one or more memories 1004, a bus interface 1006, a bus 1008, and a transceiver 1010. Examples of the one or more processors 1002 may include microprocessors, microcontrollers, digital signal processors (DSPs), field programmable gate arrays (FPGAs), programmable logic devices (PLDs), state machines, gated logic, discrete hardware circuits, or suitable hardware configured to perform the various functionality described throughout this disclosure. In various examples, the DU 1000 may be configured to perform one or more of the functions described in FIGS. 1-9. That is, the one or more processors 1002, as utilized in the DU 1000, may be used to implement one or more of the processes and procedures described in FIGS. 1-9.

The one or more processors 1002 may in some instances be implemented via a baseband or modem chip and in additional implementations, the one or more processors 1002 may comprise a number of devices distinct and different from a baseband or modem chip. And as mentioned above, various hardware arrangements and components outside of a baseband modem processor can be used in implementations, including RF-chains, power amplifiers, modulators, buffers, interleavers, adders/summers, etc.

The one or more memories 1004 may include suitable circuitry, interfaces, and/or logic configured to store instructions (e.g., computer-executable code) that when executed by the one or more processors 1002 may cause the one or more processors 1002 to perform the operations illustrated in FIGS. 1-9, or additional operations to optimize channel information signaling in fronthaul interface. The DU 1000 may store data within the one or more memories 1004 by transforming the physical state of one or more physical storage units (e.g., transistors, magnetic domains, optical pits, gate cells, phase change materials, etc.) in the one or more memories 1004 to reflect the information being stored. The specific transformation of physical state can depend on various factors. Examples of such factors can include, but are not limited to, the technology used to implement the physical storage units, whether the one or more memories 1004 is characterized as primary or secondary storage, and the like.

In further aspects, the one or more memories 1004 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a RAM, a ROM, a PROM, an EPROM, an EEPROM, a register, a removable disk, and any suitable medium for storing software and/or instructions that may be accessed and read by a computer.

In numerous examples, the DU 1000 may be implemented with a bus architecture, represented generally by the bus 1008. The bus 1008 may include one or more interconnecting buses and/or bridges based on the specific application of the DU 1000 and the overall design constraints. The bus 1008 may communicatively couple various circuits including the one or more processors 1002, the one or more memories 1004, and the bus interface 1006. In some examples, bus 1008 may also link various circuits such as timing sources, peripherals, voltage regulators, and power management circuits, that are well known in the art, and therefore, will not be described any further.

In some aspects, the bus interface 1006 may provide an interface between the bus 1008 and the transceiver 1010. In some more aspects, the DU 1000 may further include an interface 1012. The transceiver 1010 may provide a communication interface or means for communicating with various apparatus over a wireless transmission medium. In some additional examples, the DU 1000 may include two or more transceivers, each configured to communicate with a respective network type (e.g., terrestrial or non-terrestrial). The interface 1012 may provide a communication interface or means of communicating with various apparatuses and devices (e.g., devices housed within the same apparatus as the DU 1000 or external apparatuses) over an internal bus or external transmission medium, such as an Ethernet cable. Depending upon the nature of the apparatus, the interface 1012 may optionally include a user interface.

The one or more processors 1002 may be responsible for managing the bus 1008 and general processing, including the execution of software stored on the one or more memories 1004. The software, when executed by the one or more processors 1002, may cause the one or more processors 1002 to perform the various functions described in FIGS. 1-9. In some examples, the one or more memories 1004 may be used for storing data that is manipulated by the one or more processors 1002 when executing the software.

In numerous examples, the software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In numerous aspects, the one or more processors 1002, may include circuitry configured for various functions. The one or more processors 1002 may include communication and processing circuitry 1014. The communication and processing circuitry 1014 may be configured to communicate with an RU (for example, the RU 108, the RU 204, or the RU 304) via the transceiver 1010 and a fronthaul link.

In various aspects, the communication and processing circuitry 1014 may obtain information from a component of the DU 1000 (for example, from the transceiver 1010 that receives the information via radio frequency signaling or some type of signaling suitable for the applicable communication medium), process (for example, decode) the information, and output the processed information. For example, the communication and processing circuitry 1014 may output the information to a different component of the one or more processors 1002, to the one or more memories 1004, or to the bus interface 1006. In some examples, the communication and processing circuitry 1014 may receive one or more of signals, messages, information, or any combination thereof. In some examples, the communication and processing circuitry 1014 may receive information via one or more channels. In some examples, the communication and processing circuitry 1014 may include functionality for a means for receiving.

In some aspects, the communication and processing circuitry 1014 may obtain information (for example, from a different component of the one or more processors 1002, the one or more memories 1004, or the bus interface 1006), process (for example, encode) the information, and output the processed information. For example, the communication and processing circuitry 1014 may output the information to the transceiver 1010. In some examples, the communication and processing circuitry 1014 may transmit information via one or more channels. In some examples, the communication and processing circuitry 1014 may include functionality for a means for transmitting. In various examples, the communication and processing circuitry 1014 may further be configured to execute communication and processing software 1016 included on the one or more memories 1004 to implement one or more functions described herein.

In numerous additional aspects, the one or more processors 1002 may include management plane processing circuitry 1018 configured to perform management plane processing-related operations as discussed herein (for example, receiving an M-plane message from an RU and processing the M-plane message to determine capabilities of the RU). The management plane processing circuitry 1018 may further be configured to execute management plane processing software 1020 included on the one or more memories 1004 to implement one or more functions described herein.

In various aspects, the one or more processors 1002 may include control plane processing circuitry 1022 configured to perform control plane processing-related operations as discussed herein (for example, receiving C-plane messages from the RU, processing the C-plane messages, or the like). The control plane processing circuitry 1022 may further be configured to execute control plane processing software 1024 included on the one or more memories 1004 to implement one or more functions described herein.

In some implementations, the DU 1000 may be configured to operate as the DU 106, the DU 202, and/or the DU 302 described herein. In some more implementations, the DU 106, the DU 202, and/or the DU 302 described herein may correspond to (or may be included in) the DU 1000. For example, the one or more processors 1002 or any remaining components of the DU 1000 may enable the DU 1000 to perform the operations of one or more processes (for example, the process 900) described herein.

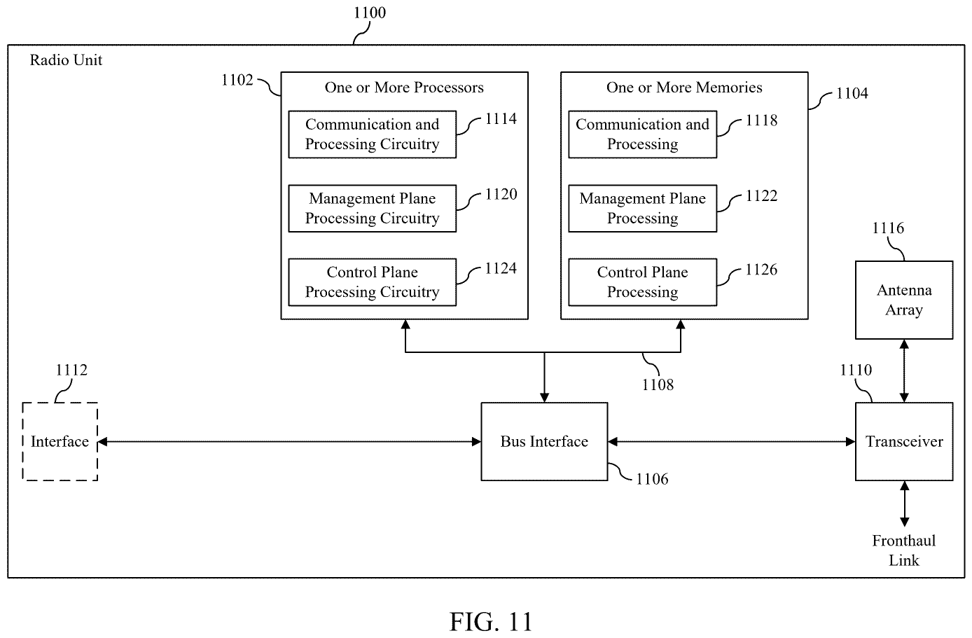

FIG. 11 is a diagram that illustrates an example of an RU 1100, in accordance with certain aspects of the present disclosure. FIG. 11 is explained in conjunction with FIGS. 1-9. The RU 1100 may enable wireless communication with a DU and/or one or more communication devices (for example, UEs). In some examples, the RU 1100 may correspond to the NR base station, the LTE base station, the eNB, the gNB, the access point, the TRP, or the like.

In some aspects, the RU 1100 may include one or more processors 1102, one or more memories 1104, a bus interface 1106, a bus 1108, and a transceiver 1110. Examples of the one or more processors 1102 may include microprocessors, microcontrollers, DSPs, FPGAs, PLDs, state machines, gated logic, discrete hardware circuits, and suitable hardware configured to perform the various functionalities described throughout this disclosure. In various examples, the RU 1100 may be configured to perform one or more of the functions described in FIGS. 1-9. That is, the one or more processors 1102, as utilized in the RU 1100, may be used to implement one or more of the processes and procedures described in FIGS. 1-9.

The one or more processors 1102 may in some instances be implemented via a baseband or modem chip and in additional implementations, the one or more processors 1102 may itself comprise a number of devices distinct and different from a baseband or modem chip (e.g., in such scenarios as may work in concert to achieve embodiments discussed herein). And as mentioned above, various hardware arrangements and components outside of a baseband modem processor can be used in implementations, including RF-chains, power amplifiers, modulators, buffers, interleavers, adders/summers, etc.

The one or more memories 1104 may include suitable circuitry, interfaces, and/or logic configured to store instructions (e.g., computer-executable code) that when executed by the one or more processors 1102 may cause the one or more processors 1102 to perform the operations illustrated in FIGS. 1-9, or additional operations to optimize channel information signaling in fronthaul interface. The RU 1100 may store data within the one or more memories 1104 by transforming the physical state of one or more physical storage units (e.g., transistors, magnetic domains, optical pits, gate cells, phase change materials, etc.) in the one or more memories 1104 to reflect the information being stored. The specific transformation of physical state can depend on various factors. Examples of such factors can include, but are not limited to, the technology used to implement the physical storage units, whether the one or more memories 1104 is characterized as primary or secondary storage, and the like.

In further aspects, the one or more memories 1104 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a RAM, a ROM, a PROM, an EPROM, an EEPROM, a register, a removable disk, and any suitable medium for storing software and/or instructions that may be accessed and read by a computer.

In numerous examples, the RU 1100 may be implemented with a bus architecture, represented generally by the bus 1108. The bus 1108 may include one or more interconnecting buses and/or bridges based on the specific application of the RU 1100 and the overall design constraints. The bus 1108 may communicatively couple various circuits including the one or more processors 1102, the one or more memories 1104, and the bus interface 1106. In some examples, bus 1108 may also link various circuits such as timing sources, peripherals, voltage regulators, and power management circuits, that are well known in the art, and therefore, will not be described any further.

In some aspects, the bus interface 1106 may provide an interface between the bus 1108 and the transceiver 1110. In some more aspects, the RU 1100 may further include an interface 1112. The transceiver 1110 may provide a communication interface or means for communicating with various apparatus over a wireless transmission medium. In some additional examples, the RU 1100 may include two or more transceivers, each configured to communicate with a respective network type (e.g., terrestrial or non-terrestrial). The interface 1112 may provide a communication interface or means of communicating with various apparatuses and devices (e.g., devices housed within the same apparatus as the RU 1100 or external apparatuses) over an internal bus or external transmission medium, such as an Ethernet cable. Depending upon the nature of the apparatus, the interface 1112 may optionally include a user interface.

The one or more processors 1102 may be responsible for managing the bus 1108 and general processing, including the execution of software stored on the one or more memories 1104. The software, when executed by the one or more processors 1102, may cause the one or more processors 1102 to perform the various functions described in FIGS. 1-9. In some examples, the one or more memories 1104 may be used for storing data that is manipulated by the one or more processors 1102 when executing the software.

In numerous examples, the software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In numerous aspects, the one or more processors 1102, may include circuitry configured for various functions. The one or more processors 1102 may include communication and processing circuitry 1114. In some examples, the communication and processing circuitry 1114 may be configured to communicate with a UE (for example, the UE 110, the UE 206, or the UE 306) via the transceiver 1110 and an antenna array 1116. In some more examples, the communication and processing circuitry 1114 may be configured to communicate with a DU (for example, the DU 106, the DU 202, or the DU 302) via the transceiver 1110 and a fronthaul link.

In various aspects, the communication and processing circuitry 1114 may obtain information from a component of the RU 1100 (for example, from the transceiver 1110 that receives the information via radio frequency signaling or some type of signaling suitable for the applicable communication medium), process (for example, decode) the information, and output the processed information. For example, the communication and processing circuitry 1114 may output the information to a different component of the one or more processors 1102, to the one or more memories 1104, or to the bus interface 1106. In some examples, the communication and processing circuitry 1114 may receive one or more of signals, messages, information, or any combination thereof. In some examples, the communication and processing circuitry 1114 may receive information via one or more channels. In some examples, the communication and processing circuitry 1114 may include functionality for a means for receiving.

In some aspects, the communication and processing circuitry 1114 may obtain information (for example, from a different component of the one or more processors 1102, the one or more memories 1104, or the bus interface 1106), process (for example, encode) the information, and output the processed information. For example, the communication and processing circuitry 1114 may output the information to the transceiver 1110. In some examples, the communication and processing circuitry 1114 may transmit information via one or more channels. In some examples, the communication and processing circuitry 1114 may include functionality for a means for transmitting. In various examples, the communication and processing circuitry 1114 may further be configured to execute communication and processing software 1118 included on the one or more memories 1104 to implement one or more functions described herein.

In numerous additional aspects, the one or more processors 1102 may include management plane processing circuitry 1120 configured to perform management plane processing-related operations as discussed herein (for example, generating an M-plane message). The management plane processing circuitry 1120 may further be configured to execute management plane processing software 1122 included on the one or more memories 1104 to implement one or more functions described herein.

In various aspects, the one or more processors 1102 may include control plane processing circuitry 1124 configured to perform control plane processing-related operations as discussed herein (for example, generating C-plane messages, transmitting the C-plane messages, or the like). The control plane processing circuitry 1124 may further be configured to execute control plane processing software 1126 included on the one or more memories 1104 to implement one or more functions described herein.

In some implementations, the RU 1100 may be configured to operate as the RU 108, the RU 204, and/or the RU 304 described herein. In some more implementations, the RU 108, the RU 204, and/or the RU 304 described herein may correspond to (or may be included in) the RU 1100. For example, the one or more processors 1102 or any remaining components of the RU 1100 may enable the RU 1100 to perform the operations of one or more processes (for example, the process 900) described herein.

Some implementation examples are described in the following numbered aspects:

Aspect 1: A method for optimization of channel information signaling in fronthaul interface, comprising: in a first network node: receiving, from a second network node, an antenna configuration message associated with a plurality of antennas, wherein the antenna configuration message indicates a set of active antennas of the plurality of antennas and a set of inactive antennas of the plurality of antennas; receiving a first sounding reference signal associated with a user equipment (UE); generating, based on the antenna configuration message and the first sounding reference signal, a first control plane (C-plane) message that indicates a first set of channel estimates for the set of active antennas, wherein in the first C-plane message, a second set of channel estimates for the set of inactive antennas is absent; and transmitting the first C-plane message to the second network node.

Aspect 2: The method of aspect 1, wherein the first C-plane message comprises a format indicator to specify that the first C-plane message comprises channel estimate information in a reduced format, and the channel estimate information in the reduced format exclusively indicates the first set of channel estimates for the set of active antennas.

Aspect 3: The method of any of aspects 1 and 2, further comprising: transmitting to the second network node, a capability indicator specifying that the first network node supports channel estimate information in a reduced format, wherein the channel estimate information in the reduced format is independent of one or more inactive antennas of the plurality of antennas; and receiving from the second network node, based on the transmission of the capability indicator, a response indicating that the second network node supports the channel estimate information in the reduced format.

Aspect 4: The method of aspect 3, wherein the transmission of the capability indicator is via a management plane (M-plane) message.

Aspect 5: The method of any of aspects 1 through 4, wherein in the first C-plane message, each channel estimate of the first set of channel estimates is associated with an antenna identifier of a corresponding active antenna of the set of active antennas.

Aspect 6: The method of any of aspects 1 through 5, further comprising: receiving a second SRS associated with the UE after the reception of the first SRS; determining a third set of channel estimates for the set of active antennas based on the second SRS; generating a second C-plane message that indicates one or more channel estimates of the determined third set of channel estimates, wherein the one or more channel estimates of the determined third set of channel estimates deviate from corresponding one or more channel estimates of the first set of channel estimates, and in the second C-plane message, at least one channel estimate of the third set of channel estimates that is identical to a corresponding channel estimate of the first set of channel estimates is absent; and transmitting the second C-plane message to the second network node.

Aspect 7: The method of any of aspects 1 through 6, wherein the first C-plane message corresponds to a Section Type 6 (ST6) message.

Aspect 8: The method of any of aspects 1 through 7, wherein the set of active antennas corresponds to one or more first antennas among the plurality of antennas that are switched ON, and the set of inactive antennas corresponds to one or more second antennas among the plurality of antennas that are switched OFF.

Aspect 9: The method of any of aspects 1 through 8, wherein the antenna configuration message corresponds to one of a Section Type 4 (ST4) message or a management plane message.

Aspect 10: The method of any of aspects 1 through 9, wherein the antenna configuration message comprises a bitmap having a plurality of bits, each bit of the plurality of bits is mapped to a corresponding antenna of the plurality of antennas, and each bit of the plurality of bits has one of a first value indicating that the corresponding antenna is active, or a second value indicating that the corresponding antenna is inactive.

Aspect 11: The method of aspect 10, wherein in the first C-plane message, the first set of channel estimates for the set of active antennas is indicated in a same sequence in which the set of active antennas is indicated in the bitmap of the antenna configuration message.

Aspect 12: The method of any of aspects 1 through 11, wherein each channel estimate of the first set of channel estimates is associated with a plurality of physical resource blocks associated with the UE.

Aspect 13: A method for optimization of channel information signaling in fronthaul interface, comprising: in a first network node: transmitting, to a second network node, an antenna configuration message associated with a plurality of antennas, wherein the antenna configuration message indicates a set of active antennas of the plurality of antennas and a set of inactive antennas of the plurality of antennas; and receiving, from the second network node, a first control plane (C-plane) message based on the transmission of the antenna configuration message, wherein the first C-plane message indicates a first set of channel estimates for the set of active antennas, and in the first C-plane message, a second set of channel estimates for the set of inactive antennas is absent.

Aspect 14: The method of aspect 13, wherein the first C-plane message comprises a format indicator to specify that the first C-plane message comprises channel estimate information in a reduced format, and the channel estimate information in the reduced format exclusively indicates the first set of channel estimates for the set of active antennas.

Aspect 15: The method of any of aspects 13 and 14, further comprising: receiving, from the second network node, a capability indicator specifying that the second network node supports channel estimate information in a reduced format, wherein the channel estimate information in the reduced format is independent of one or more inactive antennas of the plurality of antennas; and transmitting, to the second network node, based on the reception of the capability indicator, a response indicating that the first network node supports the channel estimate information in the reduced format.

Aspect 16: The method of any of aspects 13 through 15, wherein in the first C-plane message, each channel estimate of the first set of channel estimates is associated with an antenna identifier of a corresponding active antenna of the set of active antennas.

Aspect 17: The method of aspect 16, further comprising: receiving a second C-plane message that indicates one or more channel estimates for one or more active antennas of the set of active antennas, wherein: the one or more channel estimates deviate from corresponding one or more channel estimates of the first set of channel estimates, and in the second C-plane message, at least one channel estimate of at least one active antenna of the set of active antennas is absent.

Aspect 18: The method of any of aspects 13 through 15, wherein in the first C-plane message, the first set of channel estimates for the set of active antennas is indicated in a same sequence in which the set of active antennas is indicated in the antenna configuration message.

Aspect 19: The method of any of aspects 13 through 18, wherein the set of active antennas corresponds to one or more first antennas among the plurality of antennas that are switched ON, and the set of inactive antennas corresponds to one or more second antennas among the plurality of antennas that are switched OFF.

Aspect 20: An apparatus for wireless communication at a network node, comprising: one or more processors; one or more memories coupled with the one or more processors; and instructions stored in the one or more memories and executable by the one or more processors to cause the apparatus to perform a method of any of aspects 1 through 12.

Aspect 21: A non-transitory computer-readable medium storing code for wireless communication, at a network node, the code comprising instructions executable by one or more processors to perform a method of any of aspects 1 through 12.

Aspect 22: An apparatus for wireless communication at a network node, comprising: one or more processors; one or more memories coupled with the one or more processors; and instructions stored in the one or more memories and executable by the one or more processors to cause the apparatus to perform a method of any of aspects 13 through 19.

Aspect 23: An apparatus for wireless communication at a network node, comprising at least one means for performing a method of any of aspects 13 through 19.

Aspect 24: A non-transitory computer-readable medium storing code for wireless communication at a network node, the code comprising instructions executable by one or more processors to perform a method of any of aspects 13 through 19.

It should be noted that the methods described herein describe possible implementations, and that the operations and the steps may be rearranged or otherwise modified and that other implementations are possible. Further, aspects from two or more of the methods may be combined.

As used herein, the phrase ‘one or more processors are individually or collectively configured to’ may encompass various implementations, including but not limited to: (A) processors that are programmed and capable of performing the function, regardless of whether execution is occurring at a given time; (B) processors actively executing instructions to perform the function; and (C) processors that, when triggered by an event or condition, initiate execution of the function. This interpretation is not intended to limit the scope of the claims to only an actively functioning device.

Unless explicitly stated otherwise, the recitation of “one or more processors are individually or collectively configured to” is not intended to require that all operations be performed by the same individual processor. Rather, the described functionality may be distributed among multiple processors operating individually or collectively, including configurations in which different processors are configured to perform different subsets of the operations. Such distribution may be static or dynamic and concurrent or sequential.

It is understood that the specific order or hierarchy of steps in the processes disclosed is an illustration of exemplary approaches. Based on design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The aforementioned description is provided to enable any person skilled in the art to practice the various aspects described herein. Various modifications to these aspects will be readily apparent to those skilled in the art, and the generic principles defined herein may be applied to further aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.” Further, unless stated otherwise, terms such as “first” and “second” are used to arbitrarily distinguish between the elements such terms describe. Thus, these terms are not necessarily intended to indicate temporal or other prioritization of such elements. The term “coupled” may refer to at least one of direct or indirect coupling that may not necessarily be by way of mechanical or any physical means. Further, a system or method that “comprises”, “has”, or “includes” one or more elements possesses those one or more elements but is not limited to possessing only those one or more elements.

What is claimed is:

1. A first network node for wireless communication, the first network node comprising:
one or more memories; and
one or more processors coupled to the one or more memories, the one or more processors individually or collectively configured to cause the first network node to:
receive, from a second network node, an antenna configuration message associated with a plurality of antennas, wherein the antenna configuration message indicates a set of active antennas of the plurality of antennas and a set of inactive antennas of the plurality of antennas;
receive a first sounding reference signal (SRS) associated with a user equipment (UE);
generate, based on the antenna configuration message and the first SRS, a first control plane (C-plane) message that indicates a first set of channel estimates for the set of active antennas, wherein in the first C-plane message, a second set of channel estimates for the set of inactive antennas is absent; and
transmit the first C-plane message to the second network node.

2. The first network node of claim 1, wherein
the first C-plane message comprises a format indicator to specify that the first C-plane message comprises channel estimate information in a reduced format, and
the channel estimate information in the reduced format exclusively indicates the first set of channel estimates for the set of active antennas.

3. The first network node of claim 1, wherein the one or more processors individually or collectively are further configured to cause the first network node to:
transmit, to the second network node, a capability indicator specifying that the first network node supports channel estimate information in a reduced format, wherein the channel estimate information in the reduced format is independent of one or more inactive antennas of the plurality of antennas; and
receive, from the second network node, based on the transmission of the capability indicator, a response indicating that the second network node supports the channel estimate information in the reduced format.

4. The first network node of claim 3, wherein the transmission of the capability indicator is via a management plane (M-plane) message.

5. The first network node of claim 1, wherein in the first C-plane message, each channel estimate of the first set of channel estimates is associated with an antenna identifier of a corresponding active antenna of the set of active antennas.

6. The first network node of claim 5, wherein the one or more processors individually or collectively are further configured to cause the first network node to:
receive a second SRS associated with the UE after the reception of the first SRS;
determine a third set of channel estimates for the set of active antennas based on the second SRS;
generate a second C-plane message that indicates one or more channel estimates of the determined third set of channel estimates, wherein
the one or more channel estimates of the determined third set of channel estimates deviate from corresponding one or more channel estimates of the first set of channel estimates, and
in the second C-plane message, at least one channel estimate of the third set of channel estimates that is identical to a corresponding channel estimate of the first set of channel estimates is absent; and
transmit the second C-plane message to the second network node.

7. The first network node of claim 1, wherein the first C-plane message corresponds to a Section Type 6 (ST6) message.

8. The first network node of claim 1, wherein
the set of active antennas corresponds to one or more first antennas among the plurality of antennas that are switched ON, and
the set of inactive antennas corresponds to one or more second antennas among the plurality of antennas that are switched OFF.

9. The first network node of claim 1, wherein the antenna configuration message corresponds to one of a Section Type 4 (ST4) message or a management plane message.

10. The first network node of claim 1, wherein
the antenna configuration message comprises a bitmap having a plurality of bits,
each bit of the plurality of bits is mapped to a corresponding antenna of the plurality of antennas, and
each bit of the plurality of bits has one of a first value indicating that the corresponding antenna is active, or a second value indicating that the corresponding antenna is inactive.

11. The first network node of claim 10, wherein in the first C-plane message, the first set of channel estimates for the set of active antennas is indicated in a same sequence in which the set of active antennas is indicated in the bitmap of the antenna configuration message.

12. The first network node of claim 1, wherein each channel estimate of the first set of channel estimates is associated with a plurality of physical resource blocks associated with the UE.

13. A first network node for wireless communication, the first network node comprising:
one or more memories; and
one or more processors coupled to the one or more memories, the one or more processors individually or collectively configured to cause the first network node to:
transmit, to a second network node, an antenna configuration message associated with a plurality of antennas, wherein the antenna configuration message indicates a set of active antennas of the plurality of antennas and a set of inactive antennas of the plurality of antennas; and
receive, from the second network node, a first control plane (C-plane) message based on the transmission of the antenna configuration message, wherein
the first C-plane message indicates a first set of channel estimates for the set of active antennas, and
in the first C-plane message, a second set of channel estimates for the set of inactive antennas is absent.

14. The first network node of claim 13, wherein
the first C-plane message comprises a format indicator to specify that the first C-plane message comprises channel estimate information in a reduced format, and
the channel estimate information in the reduced format exclusively indicates the first set of channel estimates for the set of active antennas.

15. The first network node of claim 13, wherein the one or more processors individually or collectively are further configured to cause the first network node to:
receive, from the second network node, a capability indicator specifying that the second network node supports channel estimate information in a reduced format, wherein the channel estimate information in the reduced format is independent of one or more inactive antennas of the plurality of antennas; and
transmit, to the second network node, based on the reception of the capability indicator, a response indicating that the first network node supports the channel estimate information in the reduced format.

16. The first network node of claim 13, wherein in the first C-plane message, each channel estimate of the first set of channel estimates is associated with an antenna identifier of a corresponding active antenna of the set of active antennas.

17. The first network node of claim 16, wherein:
the one or more processors are individually or collectively further configured to cause the first network node to:
receive a second C-plane message that indicates one or more channel estimates for one or more active antennas of the set of active antennas, wherein:
the one or more channel estimates deviate from corresponding one or more channel estimates of the first set of channel estimates, and
in the second C-plane message, at least one channel estimate of at least one active antenna of the set of active antennas is absent.

18. The first network node of claim 13, wherein
the set of active antennas corresponds to one or more first antennas among the plurality of antennas that are switched ON, and
the set of inactive antennas corresponds to one or more second antennas among the plurality of antennas that are switched OFF.

19. The first network node of claim 13, wherein in the first C-plane message, the first set of channel estimates for the set of active antennas is indicated in a same sequence in which the set of active antennas is indicated in the antenna configuration message.

20. A wireless communication method, comprising:
in a first network node:
receiving, from a second network node, an antenna configuration message associated with a plurality of antennas, wherein the antenna configuration message indicates a set of active antennas of the plurality of antennas and a set of inactive antennas of the plurality of antennas;
receiving a first sounding reference signal associated with a user equipment (UE);
generating, based on the antenna configuration message and the first SRS, a first control plane (C-plane message) that indicates a first set of channel estimates for the set of active antennas, wherein in the first C-plane message, a second set of channel estimates for the set of inactive antennas is absent; and
transmitting the first C-plane message to the second network node.
